(19) United States
(12) Patent Application Publication
(10) Pub. No.: US 2009/0141001 A1
(43) Pub. Date: Jun. 4, 2009

(54) DISPLAY APPARATUS, LIQUID CRYSTAL DISPLAY APPARATUS, POSITION DETECTION SYSTEM AND POSITION DETECTION METHOD

(76) Inventors: Kazuo Kuroda, Saitama (JP); Akira Imamura, Saitama (JP); Kei Tanaka, Tokyo (JP)

Correspondence Address: NIXON & VANDERHYE, PC, 901 NORTH GLEBE ROAD, 11TH FLOOR, ARLINGTON, VA, 22203, US

(21) Appl. No.: 12/090,281

(22) PCT Filed: Oct. 16, 2006
(86) PCT No.: PCT/JP2006/320587

§ 371 Date: Jul. 10, 2008

(30) Foreign Application Priority Data
Oct. 17, 2005 (JP) 2005-301374

(51) Int. Cl. G06F 3/042; G09F 13/08; G02F 1/13357; G09G 3/36

(52) U.S. Cl. 345/175; 362/97.1; 349/61; 345/102

(57) ABSTRACT

Backlight of a backlight device (3) attached to a liquid crystal panel device (2) is created by a multitude of light emitting diodes, and light emitted from each light emitting diode is modulated by position information indicating the position of a display screen (21A). The light receiving device (4) receives the backlight, modulates it, takes out the position information and detects the position on a display screen (21A) based on the position information.

### TECHNICAL FIELD

The present invention relates to a display apparatus, such as a liquid crystal display apparatus, a plasma display apparatus, and an organic EL (Electro-luminescence) display apparatus, and more specifically relates to a position detection system for and a position detection method of detecting a position in a display surface on such a display apparatus, and further relates to a display apparatus provided with such a position detection function.

### BACKGROUND ART

As an apparatus which can detect a position in a screen (display surface) of a display apparatus, a touch panel is known. According to the touch panel, when a user touches the screen with a finger, a pen, a stylus or the like, this contact position is detected, and coordinate information or the like, which indicates the contact position, is sent to a computer or the like. This type of touch panel is used for a PDA (Personal Digital Assistance), a high-functional mobile phone, a car navigation apparatus, an ATM (Automatic Teller Machine) at a bank, a ticket vending machine at a station, and the like.

### DISCLOSURE OF INVENTION

### Subject to be Solved by the Invention

There are various types of methods of detecting the contact position on the currently popular touch panel: for example, a resistive film method of detecting the contact by using a resistive film, an analog capacitance coupling method of detecting a change in an electric field caused by the contact, an infrared method of detecting infrared rays being blocked by the contact, or the like.

In the resistive film method, the film is provided on the screen of the display apparatus. Thus, visibility on the screen may decrease in some cases. Moreover, in the resistive film method, the film is pressed down to detect the contact, which easily damages the film. Thus, it is hard to increase the durability of the display apparatus equipped with the touch panel.

Moreover, in the analog capacitance coupling method, a conductive thin film is provided on the screen of the display apparatus. Thus, the visibility on the screen may decrease in some cases.

On the other hand, the infrared method does not require anything on the screen of the display apparatus. Thus, the visibility is excellent. In this method, however, an infrared light emitting diode and a photo transistor are provided in a frame portion of the screen. Thus, the frame portion requires a space to be provided with those members, which makes it difficult to thin the frame portion and reduces the width of the frame portion.

Moreover, in any of the aforementioned contact position detection methods, it is necessary to provide the display apparatus with exclusive hardware for detecting the contact position, such as the film, the conductive thin film, and the infrared light emitting diode. This may cause the complication of the hardware structure of the display apparatus, an increase in costs, an increase in a depth size, or an increase in restrictions on the setting and design in some cases.

In view of the above-exemplified problems, it is therefore a first object of the present invention to provide a display apparatus, a liquid crystal display apparatus, a position detection system and a position detection method, which can realize the simplification of the hardware structure of the display apparatus, a reduction in costs, a reduction in a size, or a reduction in restrictions on the setting and design, while realizing the position detection in the display screen.

It is a second object of the present invention to provide a display apparatus, a liquid crystal display apparatus, a position detection system and a position detection method, which allow the position detection in the display screen without adding the exclusive hardware for detecting the position in the display screen.

It is a third object of the present invention to provide a display apparatus, a liquid crystal display apparatus, a position detection system and a position detection method, which allow the position detection in the display screen without reducing the visibility of the display screen.

It is a fourth object of the present invention to provide a display apparatus, a liquid crystal display apparatus, a position detection system and a position detection method, which allow the position detection in the display screen without reducing the durability.

### Means for Solving the Subject

The above object of the present invention can be achieved by a first display apparatus provided with: a plurality of light emitting elements for generating a plurality of light emitting points, each of which emits light to a display surface to display information visually; and a modulating device for modulating the light emitted from each of the light emitting points by using position information which indicates a position in the display surface corresponding to a position of the light emitting point.

The above object of the present invention can be achieved by a second display apparatus provided with: a plurality of light emitting elements for generating a plurality of light emitting points, each of which emits light to a display surface to display information visually; and a light emission timing control device for varying light emission timing of each of the light emitting points, depending on a position of the light emitting point.

The above object of the present invention can be achieved by a first liquid crystal display apparatus provided with: a liquid crystal panel apparatus in which an electrode and a liquid crystal are provided between two substrates; and a backlight apparatus for emitting light to a display surface of the liquid crystal panel apparatus, the backlight apparatus provided with: a plurality of light emitting elements for generating a plurality of light emitting points, each of which emits light to the display surface; and a modulating device for modulating the light emitted from each of the light emitting points by using position information which indicates a position in the display surface corresponding to a position of the light emitting point.

The above object of the present invention can be achieved by a second liquid crystal display apparatus provided with: a liquid crystal panel apparatus in which an electrode and a liquid crystal are provided between two substrates; and a backlight apparatus for emitting light to a display surface of the liquid crystal panel apparatus, the backlight apparatus provided with: a plurality of light emitting elements for generating a plurality of light emitting points, each of which emits light to the display surface; and a light emission timing control device for varying light emission timing of each of the light emitting points, depending on a position of the light emitting point.

The above object of the present invention can be achieved by a first position detection system for detecting a position in a display surface to display information visually, the position detection system provided with: a light emitting apparatus for emitting light to the display surface from a rear of the display surface; and a light receiving apparatus for receiving the light emitted to the display surface, from a front side of the display surface, the light emitting apparatus provided with: a plurality of light emitting elements for generating a plurality of light emitting points, each of which emits light to the display surface; and a modulating device for modulating the light emitted from each of the light emitting points by using position information which indicates a position in the display surface corresponding to a position of the light emitting point, the light receiving apparatus provided with: a light receiving device for receiving the light, which is emitted from each of the light emitting points and which is modulated by the modulating device; a demodulating device for demodulating the light received by the light receiving device, to thereby obtain the position information; and an outputting device for outputting the position information obtained by the demodulating device.

The above object of the present invention can be achieved by a second position detection system for detecting a position in a display surface to display information visually, the position detection system provided with: a light emitting apparatus for emitting light to the display surface from a rear of the display surface; and a light receiving apparatus for receiving the light emitted to the display surface, from a front side of the display surface, the light emitting apparatus provided with: a plurality of light emitting elements for generating a plurality of light emitting points, each of which emits light to the display surface; and a light emission timing control device for varying light emission timing of each of the light emitting points, depending on a position of the light emitting point, the light receiving apparatus provided with: a light receiving device for receiving the light, which is emitted from each of the light emitting points; a position detecting device for detecting the position in the display surface on the basis of light reception timing of the light received by the light receiving device and generating position information which indicates the position; and an outputting device for outputting the position information generated by the position detecting device.

The above object of the present invention can be achieved by a first position detection method for detecting a position in a display surface, the position detection method provided with: a light emitting process of emitting light to the display surface from each of a plurality of light emitting points disposed in a rear of the display surface, the light being modulated by using position information which indicates the position in the display surface corresponding to a position of each of the plurality of light emitting points; a light receiving process of receiving the light emitted to the display surface, from a front side of the display surface, a modulating process of modulating the light received in the light receiving process, to thereby obtain the position information; and an outputting process of outputting the position information obtained in the demodulating process.

The above object of the present invention can be achieved by a second position detection method for detecting a position in a display surface, the position detection method provided with: a light emitting process of emitting light to the display surface from each of a plurality of light emitting points disposed in a rear of the display surface, in light emission timing which varies depending on the position of each of the plurality of light emitting points; a light receiving process of receiving the light emitted to the display surface, from a front side of the display surface; and a position detecting process of detecting the position in the display surface on the basis of light reception timing of the light received in the light receiving process.

These effects and other advantages of the present invention will become more apparent from the following embodiments.

### BRIEF DESCRIPTION OF DRAWINGS

FIG. 1 is a perspective view showing a position detection system of the present invention.

FIG. 2 is a front view showing a liquid crystal display system to which the position detection system of the present invention is applied.

FIG. 3 is a perspective view showing a PDA to which the position detection system of the present invention is applied.

FIG. 4 is an explanatory diagram showing a backlight apparatus in FIG. 1.

FIG. 5 is an explanatory diagram showing an irradiation range of a light emitting element.

FIG. 6 is an explanatory diagram showing a plurality of light emitting elements arranged on a backlight apparatus main body in FIG. 4.

FIG. 7 is an explanatory diagram showing a distribution in light intensity of light emitted from the light emitting elements.

FIG. 8 is an explanatory diagram showing a position information table.

FIG. 9 is an explanatory diagram showing a light emission order for the light emitting elements which belong to one group.

FIG. 10 is a waveform chart showing pulse signals for controlling the light emission of the light emitting elements.

FIG. 11 is an explanatory diagram showing another example of the arrangement of the light emitting elements.

FIG. 12 is an explanatory diagram showing a backlight apparatus in a second embodiment of the present invention.

FIG. 13 is a waveform chart showing pulse signals for controlling the light emission of the light emitting elements in the backlight apparatus shown in FIG. 12.

FIG. 14 is an explanatory diagram showing a backlight apparatus in a third embodiment of the present invention.

FIG. 15 is a waveform chart showing pulse signals for controlling the light emission of the light emitting elements in the backlight apparatus shown in FIG. 14.

FIG. 16 is an explanatory diagram showing a backlight apparatus main body in another embodiment of the present invention.

FIG. 17 is an explanatory diagram showing a light receiving apparatus in FIG. 1.

FIG. 18 is a block diagram showing a signal processing device in FIG. 17.

FIG. 19 is an explanatory diagram showing a relationship between a range of irradiation of the light receiving element and a contact position, or the like.

FIG. 20 is an explanatory diagram showing the light intensity of the light received by the light receiving apparatus in FIG. 17.

FIG. 21 is a block diagram showing a signal processing device of a light receiving apparatus in another embodiment.

### DESCRIPTION OF REFERENCE CODES

1 position detection system
2, 101, 201 liquid crystal panel apparatus
3, 50, 102, 202 backlight apparatus
4, 1.03, 203 light receiving apparatus
21A display surface
35, 76, 77, 78, 79 light receiving element
37, 82 light emission time control device
38, 83 modulation device
52 light emission timing control device
301 case
305 signal processing device
306 output device
308 light receiving system
311 demodulation device
312 light intensity detection device
313 light intensity comparison device
314, 322 position detection device
321 timing detection device

### BEST MODE FOR CARRYING OUT THE INVENTION

Hereinafter, the best mode for carrying out the invention will be explained in each embodiment in order, with reference to the drawings.

(Outline of Position Detection System)

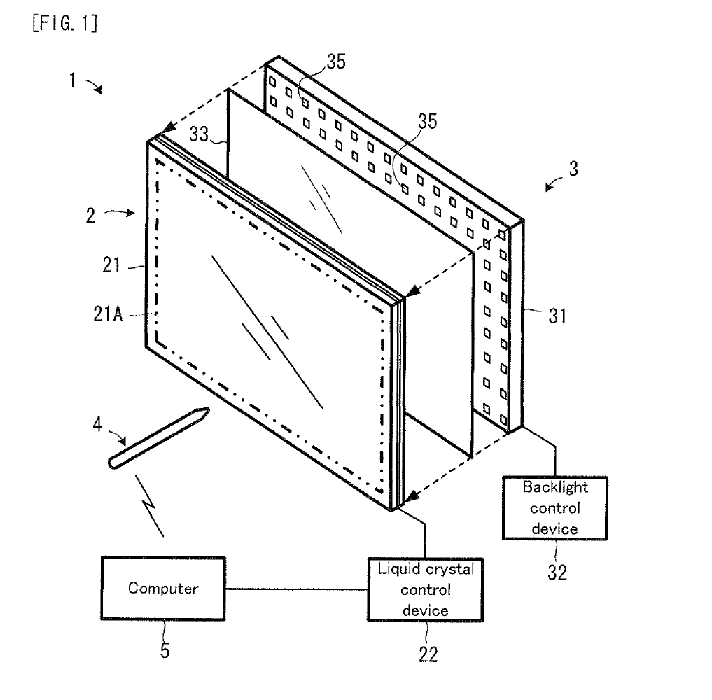

FIG. 1 shows the case that the position detection system of the present invention is applied to a liquid crystal display apparatus. A position detection system 1 in FIG. 1 can detect a position in a display surface 21A of a liquid crystal panel apparatus 2. The display surface 21A is a surface to perform thereon the visual display of information, such as a character and a figure. The position detection system 1 is provided with: a backlight apparatus 3; and a light receiving apparatus 4. Incidentally, a combination of the liquid crystal panel apparatus 2 and the backlight apparatus 3 is a specific example of the display apparatus. Moreover, the backlight apparatus 3 is a specific example of the light emitting apparatus.

The backlight apparatus 3 has a function as a backlight for emitting light to the display surface 21A from the rear of the display surface 21A. Moreover, the backlight apparatus 3 also has a function of transmitting position information in the display surface 21A. The backlight apparatus 3 is provided with a backlight apparatus main body 31, a backlight control device 32, and the like. The backlight apparatus main body 31 is provided with a plurality of light emitting elements 35. The light emitting element 35 generates light as backlight. Moreover, the backlight control device 32 is provided with a modulation circuit for high-speed modulation of the light (i.e. backlight) emitted from each light emitting element 35. The light emitted from each light emitting element 35 is modulated at high speed by using the position information which indicates a position in the display surface 21A corresponding to the position of the light emitting element 35. By this, the position information in the display surface 21A is transmitted through a medium which is the light emitted from each light emitting element 35.

The light receiving apparatus 4 has a function of pointing the position in the display surface 21A. Moreover, the light receiving apparatus 4 also has a function of detecting the position in the display surface 21A. The light receiving apparatus 4 has e.g. a pen-shaped outer surface, and has the same size as that of a pen normally used. A user holds the light receiving apparatus 4 with the hand and contacts the tip portion of the light receiving apparatus 4 on the display surface 21A from the front side of the display surface 21A of the liquid crystal panel apparatus 2. By this, it is possible to point a certain position in the display surface 21A. Moreover, a light receiving element and the like are provided in the tip portion inside the light receiving apparatus 4. Moreover, for example, a demodulation circuit, a transmission circuit, and the like are provided inside the light receiving apparatus 4. When the user contacts the tip portion of the light receiving apparatus 4 on the display surface 21A, the light (backlight) modulated by using the position information, which indicates the position in the display surface 21A corresponding to the contact position, is received by the light receiving element of the light receiving apparatus 4. The light receiving element converts the received light to an electric signal, and supplies the electric signal to the demodulation circuit. The demodulation circuit demodulates the electric signal. This provides the position information corresponding to the contact position. Then, the transmission circuit transmits the position information to a computer 5 through an electric wave or light beam. The computer 5 receives the position information transmitted from the light receiving apparatus 4, and specifies the position in the display surface 21A, for example, coordinates (X, Y), on the basis of the position information.

The liquid crystal display apparatus is provided with the liquid crystal panel apparatus 2, the backlight apparatus 3, and the like, The liquid crystal panel apparatus 2 is provided with a liquid crystal panel apparatus main body 21, a liquid crystal control device 22, and the like. The liquid crystal panel apparatus main body 21 is constructed, for example, by providing an electrode and a liquid crystal between two transparent substrates. The liquid crystal control device 22 is provided with a liquid crystal drive circuit or the like. The backlight apparatus 3 is mounted on the back surface of the liquid crystal panel apparatus 2 through a diffuser plate 33. Incidentally, for convenience of explanation, FIG. 1 shows the state that the liquid crystal panel apparatus 2, the diffuser plate 33, and the backlight apparatus 3 are disassembled.

Moreover, in order to definitely make the backlight of the backlight apparatus 3 reach to the light receiving apparatus 4, it is desirable to restrict the angle of the liquid crystal in the liquid crystal panel apparatus main body 21 so that the backlight is transmitted through the liquid crystal in a greater or less degree even if the screen is black.

The position detection system 1 operates, for example, as follows. It is assumed that the user connects the liquid crystal display apparatus to the computer 5 and uses the computer 5 to operate an OS (Operating System) program with a graphic user interface. In this case, on the display surface 21A of the liquid crystal panel apparatus 2, an icon and a button are displayed. For example, if the user wants to press the button displayed on the display surface 21A, the user holds the light receiving apparatus 4 and touches the button with the tip portion of the light receiving apparatus 4. That is, the user contacts the tip portion of the light receiving apparatus 4 onto the position at which the button is displayed in the display surface 21A. By this, the position information corresponding to the contact position is transmitted to the computer 5. Then, the computer 6 receives the position information. Then, the OS program operating in the computer 5 specifies the coordinates of the contact position on the basis of the position information, and recognizes that the button is pressed from the specification. Then, the OS program performs a process assigned to the button.

As described above, in the position detection system 1, the backlight emitted from the backlight apparatus 3 is used to perform the position detection in the display surface 21A. By this, it is possible to realize the position detection in the display surface 21A without adding exclusive hardware for detecting the position in the display surface 21A to the liquid crystal display apparatus.

That is, as described above, the conventional touch panel, which employs the resistive film method, the analog capacitance coupling method, or the infrared method, requires the exclusive hardware for detecting the position in the display surface to be added to the liquid crystal display apparatus. That is, in the conventional touch panel, it is necessary to add the film or the conductive thin film on the display surface, or add the infrared light emitting diode to the frame portion of the display panel, or the like. In contrast, in the position detection system 1, the backlight of the backlight apparatus, which is one portion of the constituent elements of the liquid crystal display apparatus in general, is used to perform the position detection in the display surface. Thus, it is unnecessary to add the exclusive hardware for detecting the position in the display surface to the liquid crystal display apparatus.

Therefore, according to the position detection system 1, it is possible to realize the simplification of the hardware structure of the display apparatus, a reduction in costs, a reduction in a size, or a reduction in restrictions on the setting and design, while realizing the position detection in the display screen 21A.

Moreover, according to the position detection system 1, it is possible to realize the position detection in the display surface 21A without reducing the visibility of the display surface 21A. That is, the conventional touch panel, which employs the resistive film method or the analog capacitance coupling method, requires the film or the conductive thin film to be added on the display surface, so that the visibility of the display surface may decrease in some cases. In contrast, in the position detection system 1, the backlight is used to perform the position detection in the display surface. Thus, it is unnecessary to provide the film or the thin film on the display surface, so that the visibility of the display surface does not decrease.

Moreover, according to the position detection system 1, it is possible to realize the position detection in the display surface without reducing the durability of the display apparatus. That is, the conventional touch panel, which employs the resistive film method, requires the film on the display surface to be pressed down to realize the position detection, which easily damages the film. Thus, it may reduce the durability of the display apparatus equipped with the touch panel in some cases. In contrast, in the position detection system 1, the backlight is used to perform the position detection, so that it is only necessary to lightly contact the light receiving apparatus 4 onto the display surface 21A in the position detection. Therefore, the display surface is hardly damaged, and it is possible to prevent the reduction in the durability of the display apparatus provided with the touch panel.

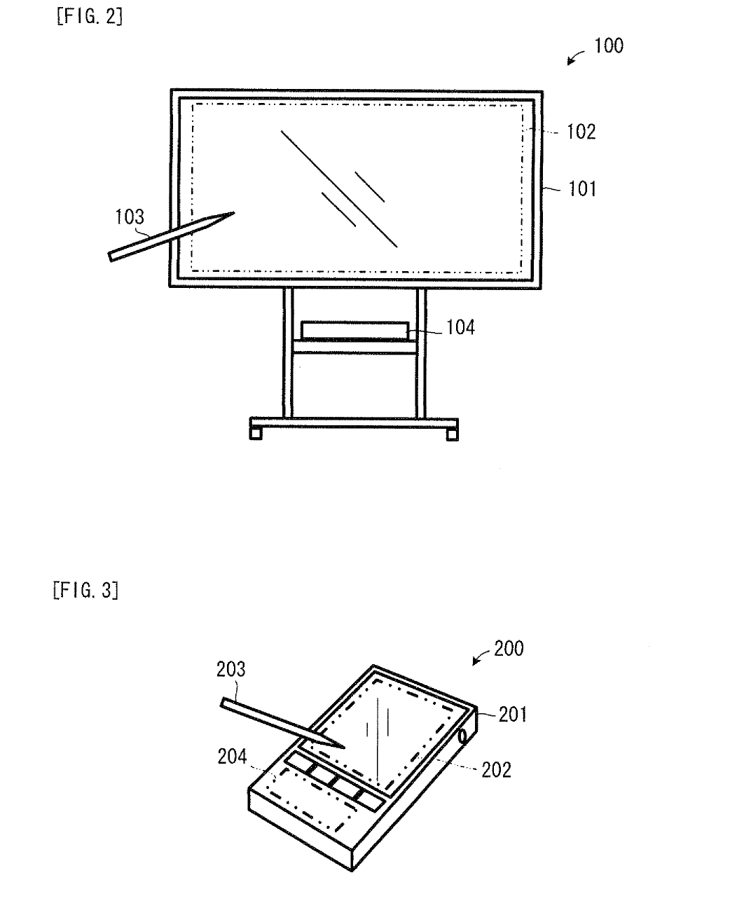

FIG. 2 shows a liquid crystal display system to which the position detection system of the present invention is applied. A liquid crystal display system 100 in FIG. 2 is, for example, a large liquid crystal display system preferable to be used for presentation at a meeting, or the like. The liquid crystal display system 100 is provided with: a liquid crystal panel apparatus 101; a backlight apparatus 102; a pen-shaped light receiving apparatus 103; and a computer 104. The liquid crystal panel apparatus 101 is provided with: a liquid crystal panel apparatus main body, which is provided with an electrode and a liquid crystal between two transparent substrates; and a liquid crystal control device, which is provided with a liquid crystal driving circuit or the like, as in the aforementioned liquid crystal panel apparatus 2. The backlight apparatus 102 is provided with: a backlight apparatus main body, which is provided with a plurality of light emitting elements; and a backlight control device, which is provided with a modulation circuit for high-speed modulation of the light emitted from the plurality of light emitting elements, as in the aforementioned backlight apparatus 3. The light receiving apparatus 103 is provided with: a light receiving element; a demodulation circuit; a transmission circuit; and the like, as in the aforementioned light receiving apparatus 4. The computer 104 has a function (e.g. OS program) for specifying a position in the display surface of the liquid crystal panel apparatus 101 on the basis of the position information transmitted from the light receiving apparatus 103.

The backlight apparatus 102 modulates the light (backlight) emitted from each light emitting element at high speed by using the position information, which indicates the position in the display surface corresponding to the position of the light emitting element. When the user contacts the tip portion of the light receiving apparatus 103 on a certain position in the display surface, the light receiving apparatus 103 receives the backlight modulated by using the position information. The light receiving apparatus 103 converts the received light to an electric signal, demodulates the electric signal, obtains the position information, and transmits the position information to a computer 104. The computer 104 receives the position information and specifies the position in the display surface that the user points using the light receiving apparatus 103. As described above, in the liquid crystal display system 100, the position detection in the display surface of the liquid crystal panel apparatus 101 is performed by using the backlight emitted from the backlight apparatus 102.

According to the liquid crystal display system 100, it is possible to realize the simplification of the hardware structure of the display apparatus, a reduction in costs, a reduction in a size, or a reduction in restrictions on the setting and design, while realizing the position detection in the display screen. Moreover, according to the liquid crystal display system 100, it is possible to realize the position detection in the display screen without reducing the visibility of the display screen. Moreover, according to the liquid crystal display system 100, it is possible to realize the position detection in the display screen without reducing the durability of the apparatus.

FIG. 3 shows a PDA to which the position detection system of the present invention is applied. A PDA 200 in FIG. 3 is a small mobile information terminal, about 80 mm in width, 18 mm in depth, and 120 mm in height. The PDA 200 is provided with: a liquid crystal panel apparatus 201; a backlight apparatus 202; a pen-shaped light receiving apparatus 203; and a computer 204. The liquid crystal panel apparatus 201 is provided with: a liquid crystal panel apparatus main body; and a liquid crystal control device, as in the aforementioned liquid crystal panel apparatus 2. The backlight apparatus 202 is provided with: a backlight apparatus main body; and a backlight control device, as in the aforementioned backlight apparatus 3. The light receiving apparatus 203 is provided with: a light receiving element; a demodulation circuit; a transmission circuit; and the like, as in the aforementioned light receiving apparatus 4. The computer 204 has a function for specifying a position in the display surface of the liquid crystal panel apparatus 201 on the basis of the position information transmitted from the light receiving apparatus 203.

Even in the PDA 200 in such a structure, as in the aforementioned liquid crystal display system 100, the position detection in the display surface of the liquid crystal panel apparatus 201 can be performed by using the backlight emitted from the backlight apparatus 202.

According to the PDA 200, it is possible to realize the simplification of the hardware structure of the display apparatus, a reduction in costs, a reduction in a size, or a reduction in restrictions on the setting and design, while realizing the position detection in the display screen. Moreover, according to the PDA 200, it is possible to realize the position detection in the display screen without reducing the visibility of the display screen and without reducing the durability of the PDA.

Incidentally, the above explanation exemplifies the case that the position detection system of the present invention is applied to any apparatus or system provided with the liquid crystal panel apparatus, such as the liquid crystal display apparatus, the liquid crystal display system, and the PDA. The present invention, however, is not limited to this but may be applied to another apparatus or system using the backlight. For example, the position detection system of the present invention can be applied to a view box (or schaukasten in German), which is used to display an X-ray film, or the like.

(Backlight Apparatus 1)

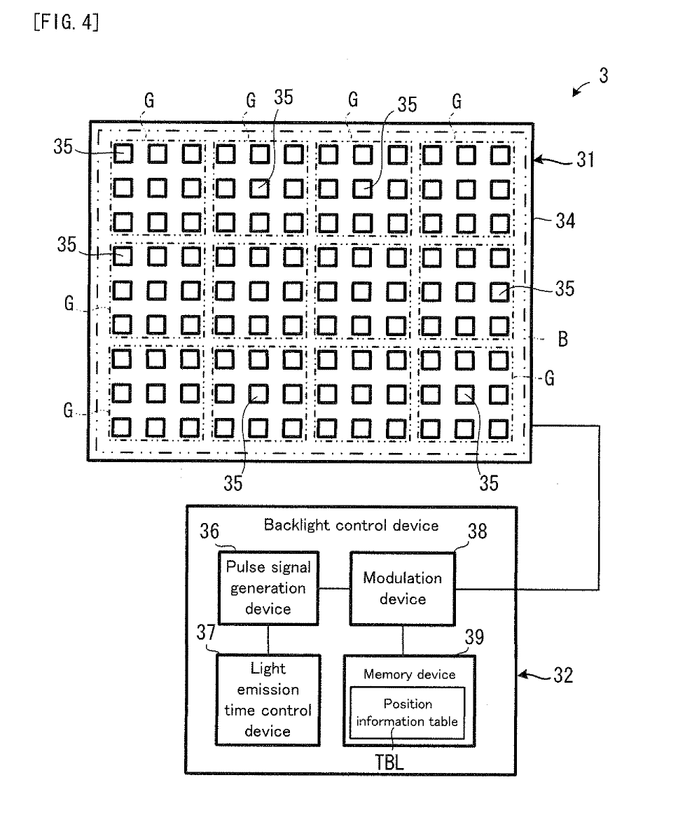

FIG. 4 shows the structure of the backlight apparatus 3 in FIG. 1. As shown in FIG. 4, the backlight apparatus 3 is provided with the backlight apparatus main body 31 and the backlight control device 32.

The backlight apparatus main body 31 has a support substrate 34, and the support substrate 34 is provided with a plurality of light emitting elements 35 thereon. The light emitting elements 35 are arranged in a matrix, for example, in a rectangular light emitting element arrangement area B having substantially the same shape and area as those of the outer shape of the display surface 21A. Moreover, the light emitting elements 35 are arranged at substantially regular intervals in both a longitudinal direction and a lateral direction.

For convenience of explanation, FIG. 4 shows an example in which the light emitting elements 35 are arranged in a matrix of 9 rows and 12 columns. In practice, however, the light emitting elements 35 are arranged, for example, in a matrix of about 60 rows and 90 columns. Incidentally, the number of the light emitting elements 35 is desirably determined appropriately in view of the area of the display surface 21A, the ensured light intensity as the backlight, the accuracy of the position detection, the irradiation range of the light emitted from each light emitting element, the cost of the light emitting element, and the like, Moreover, the number of the light emitting elements 35 may be less than the number of pixels in the liquid crystal panel apparatus 21. Incidentally, as described later, the light receiving apparatus 4 employs a new method of detecting a position between adjacent two to four light emitting elements 35 by comparing the light intensity of the lights emitted from the light emitting elements 35. Therefore, even if the arrangement interval of the light emitting elements 35 is large because the number of the light emitting elements 35 is less than the number of pixels, it is possible to realize the fine position detection by the new detection method of the light receiving apparatus 4.

Moreover the light emitting elements 35 are divided into a plurality of groups G. The grouping of the light emitting elements 35 will be described later.

The light emitting element 35 is desirably a self-emitting element, and is desirably, for example, a light emitting diode (LED). Moreover, the backlight is usually white, so the light emitting element 35 is desirably white light emitting diode which emits white light with a single element, Nevertheless the light emitting element 35 may be formed by combining a red light emitting diode, a green light emitting diode, and a blue light emitting diode, to thereby generate the white light by combining red light, green light, and blue light.

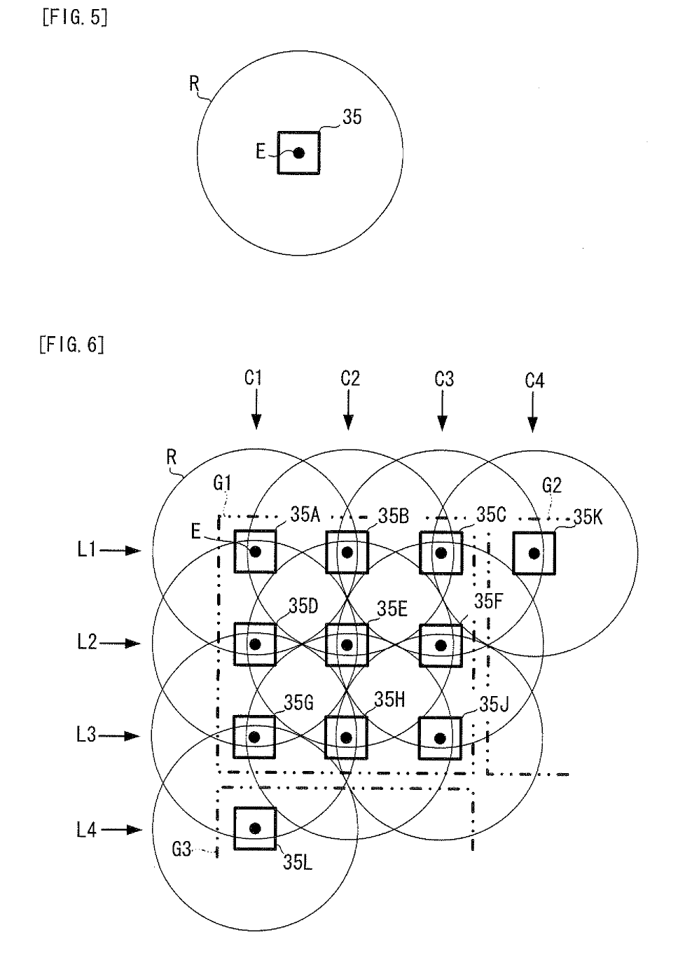

FIG. 5 shows a light emitting point E generated by one light emitting element 35 and an irradiation range R of the one light emitting element 35. The light emitting point E is a point at which the light directed to the display surface 21A from the rear of the display surface 21A is emitted, As shown in FIG. 5, on the backlight apparatus 3, one light emitting element 35 generates one light emitting point E. Moreover, since the light emitting element 35 is disposed in the rear of the display surface 21A and the light emitted from the light emitting element 35 directly becomes the light directed to the display surface 21A from the rear of the display surface 21A, the position of the light emitting element 35 in the light emitting element arrangement area B matches the position of the light emitting point E. Therefore, for example, if 5400 light emitting elements 35 are arranged in a matrix of 60 rows and 90 columns in the light emitting element arrangement area B, 5400 light emitting points E will be arranged in a matrix of 60 rows and 90 columns in the light emitting element arrangement area B.

Moreover, the irradiation range R is an irradiation range in the display surface 21A of the light emitted from the light emitting element 35 (light emitting point B). If the optical axis of the light emitted from the light emitting element 35 crosses the display surface 21A at right angles, the irradiation range R will be a circle with a predetermined radius centered on the light emitting element 35, as shown in FIG. 5.

FIG. 6 shows the overlap of the irradiation ranges R of the plurality of light emitting elements 35. As shown in FIG. 6, each light emitting element 35 is disposed so that its irradiation range R overlaps those of other adjacent light emitting elements 35.

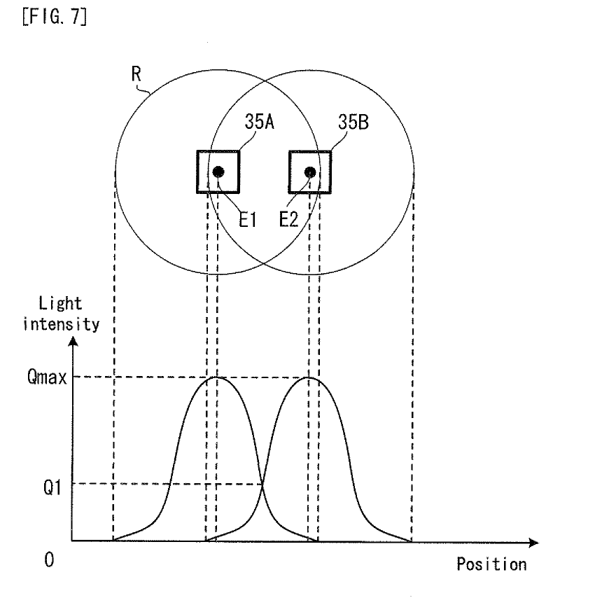

FIG. 7 shows a distribution in the light intensity in the display surface 21A of lights emitted from two light emitting elements 35A and 35B. As shown in FIG. 7, at positions in the display surface 21A corresponding to the positions of the light emitting elements 35A and 35B (i.e. light emitting points E1 and E2), the light intensity of the light (backlight) has a maximum value Qmax. Moreover, between the light emitting elements 35A and 35B, the light intensity decreases to Q1. Incidentally, the reason why the light intensity between the light emitting elements 35A and 35B is not the sum of the light intensity of the light emitting element 35A and the light intensity of the light emitting elements 35B but is the light intensity Q1, which is lower than the sum, is that light emission timing varies between the light emitting elements 35A and 35B because of a light emission time control device 37 described later and that there is no period in which the two elements simultaneously emit the lights.

Back in FIG. 4, the backlight control device 32 controls the light emission of each light emitting element 35. The backlight control device 32 is mounted, for example, on the rear surface of the backlight apparatus main body 31. The backlight control device 32 is provided with: a pulse signal generation device 36; a light emission time control device 37; a modulation device 38; and a memory device 39. The pulse signal generation device 36 is provided with e.g. a pulse signal generation circuit. The light emission time control device 37 is provided with e.g. a signal processing circuit. The modulation device 38 is provided with e.g. a modulation circuit. The memory device 39 is provided with e.g. a semiconductor memory apparatus, such as a ROM (Read Only Memory).

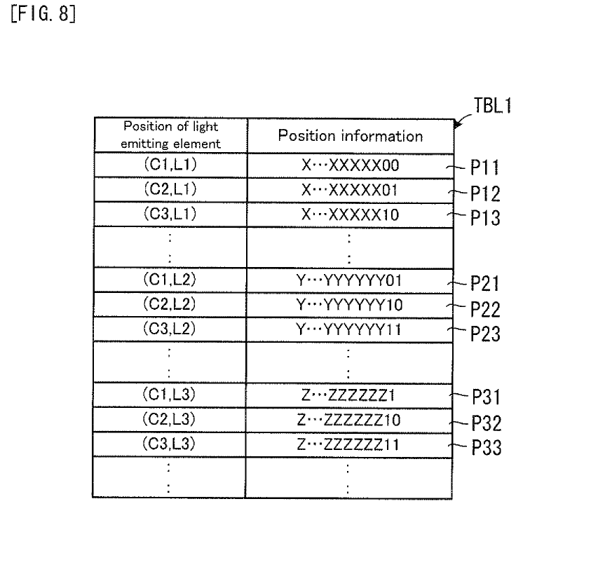

The memory device 39 stores therein a position information table TBL1. The position information table TBL1, as shown in FIG. 8, is a table describing the position information which indicates the position of each light emitting element 35, and if precisely expressing it, the position in the display surface 21A corresponding to the position in the light emitting element arrangement area B of each light emitting element 35. For example, if the number of the light emitting elements 35 is 5400 (90×60), the position information is, for example, about 13-bit binary data.

In the position information table TEL1 shown in FIG. 8, for convenience of explanation, the position of each light emitting element 35 is expressed by a column number and a row number. For example, the position of the light emitting element (C1, L1) in the position information table TBL1 indicates the light emitting element 35A with a column number C1 and a row number L1 in FIG. 6. Moreover, the position of the light emitting element (C2, L1) indicates the light emitting element 35B with a column number C2 and a row number L1 in FIG. 6.

The backlight control device 32 operates, for example, as follows. Firstly, the pulse signal generation device 36 generates a pulse signal to control the light emission of each light emitting element 35. The pulse signal is generated for each light emitting element 35.

When the pulse signal generation device 36 generates the pulse signal, the light emission time control device 37 controls the light emission timing and the light emission period of each light emitting element 35 so that the lights emitted from the light emitting elements 35 do not overlap. Specifically, the light emission time control device 37 controls the pulse signal generation device 36 and controls the rising timing and the pulse width of each pulse signal generated by the pulse signal generation device 36. Incidentally, hereinafter, the control of the light emission timing and the light emission period is referred to as “light emission time control”.

The light emission time control by the light emission time control device 37 will be explained more specifically. In the position detection system 1, the backlight apparatus 3 modulates the light emitted from each light emitting element 35 at high speed by using the position information, which indicates the position in the display surface 21A corresponding to the position of the light emitting element 35. When the user contacts the tip portion of the light receiving apparatus 4 on the display surface 21A, the light receiving apparatus 4 receives the light emitted from the light emitting element 35, extracts the position information from the light, and transmits the position information to the computer 5. Then the computer 5 specifies the position in the display surface 21A on the basis of the position information.

By the way, the irradiation ranges R of the light emitting elements 35 overlap as shown in FIG. 6. If the plurality of light emitting elements 35 with the irradiation ranges R overlapping simultaneously emit the lights, the plurality of lights emitted from the respective light emitting elements 35 simultaneously enter into the light receiving apparatus 4 when the user contacts the tip portion of the light receiving apparatus 4 onto the display surface 21A. As a result, there is the plurality of lights mixed, and it is hard to extract the position information from the respective lights. Thus, it is desirable to perform the light emission time control on the light emitting elements 35 with the irradiation ranges R overlapping so that the lights emitted from the light emitting elements 35 do not overlap. That is, it is desirable to vary the light emission timing and set the light emission period so that the lights emitted from the light emitting elements 35 do not overlap.

On the other hand, it is only if the irradiation ranges R of the light emitting elements 35 overlap that the lights emitted from the light emitting elements 35 overlap when the light emitting elements 35 simultaneously emit the lights. That is, if the irradiation ranges R of the light emitting elements 35 do not overlap, the lights emitted from the light emitting elements 35 do not overlap even if the light emitting elements 35 simultaneously emit the lights. Thus, there is no harm to perform the light emission time control to make the light emitting elements 35 without the irradiation ranges R overlapping simultaneously emit the lights.

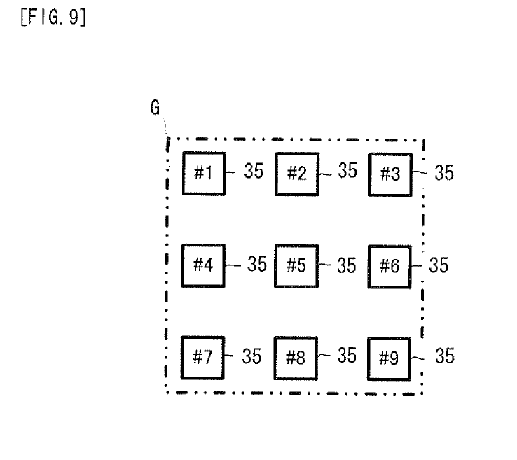

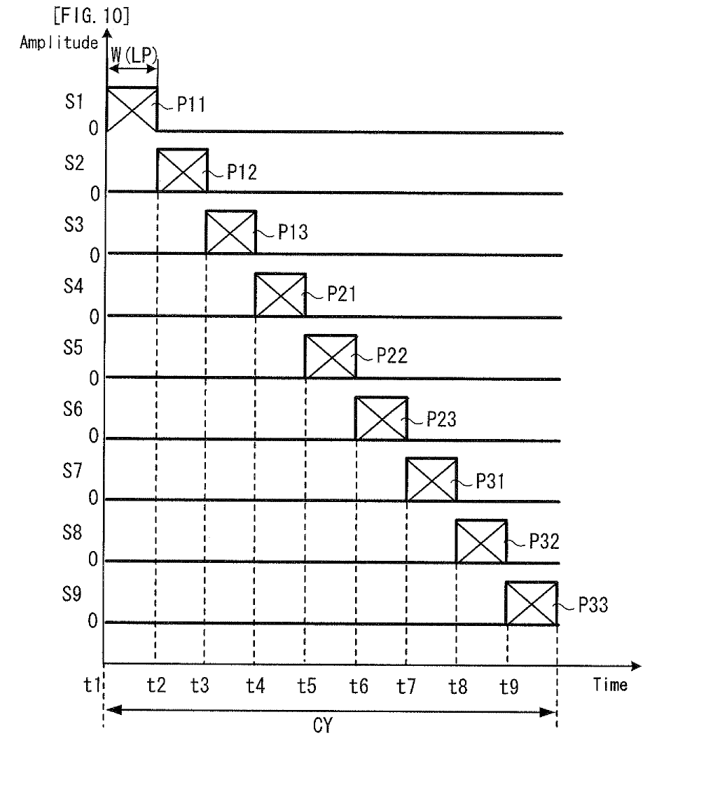

In order to realize such light emission time control, the light emission time control device 37 performs the light emission time control, for example, in the following method. Firstly, as shown in FIG. 4, the light emitting elements 35 in the light emission element arrange area B are divided into a plurality of groups G, each of which is provided with 3×3=nine light emitting elements 35 in total. In the example shown in FIG. 4, the light emitting elements 35 in the light emission element arrange area B are divided into 12 groups G. Then, as shown in FIG. 9, the order #1 to #9 of the nine light emitting elements 35, which belong to one group G, is determined. Then a light emission pattern is produced such that the nine light emitting elements 35 in the group G sequentially emit the lights in accordance with the order of #1 to #9. That is, the light emission pattern is produced which is set such that the light emission timing of the light emitting elements which belong to the group G accords to the order of #1 to #9 and that the light emission periods of the individual light emitting elements do not overlap. Specifically, as shown in FIG. 10, the rising timing of pulse signals S1 to S9, which is respectively supplied to light emitting elements 35A to 35J, is set to t1 to t9, respectively. Moreover, the pulse width of each of the pulse signals S1 to S9 is set to W. Then, the light emission time control device 37 performs the light emission time control on the nine light emitting elements 35 in the group G. Moreover, the light emission time control device 37 simultaneously performs the light emission time control by using the light emission pattern for all the groups G which exist in the light emission element arrangement area B.

This allows the light emission time control to be performed on the light emitting elements 35 with the irradiation ranges R overlapping such that the lights emitted from the light emitting elements 35 do not overlap. This mechanism will be explained with reference to FIG. 6. The irradiation range R of the light emitting element 35A in FIG. 6 overlaps the irradiation ranges R of the light emitting elements 35B, 35C, 35D, 35E and 35G. Therefore, the simultaneous light emission is to be avoided between the light emitting element 35A and the light emitting elements 35B, 35C, 35D, 35E and 35G. In the light emission pattern corresponding to the pulse signal pattern shown in FIG. 10, the light emitting elements 35A, 35B, 35C, 35D, 35E and 35G have different light emission timing, and thus the light emission periods do not overlap. Therefore, according to the light emission pattern, it is possible to avoid the simultaneous light emission between the light emitting element 35A and the light emitting elements 35B, 35C, 35D, 35E and 35G.

On the other hand, the irradiation range R of the light emitting element A does not overlap the irradiation ranges R of light emitting elements 35K and 35L, which are out of the group G1 to which the light emitting element 35A belongs. Therefore, the simultaneous light emission is allowed between the light emitting element 35A and the light emitting elements 35K and 35L. The light emission pattern corresponding to the pulse signal pattern shown in FIG. 10 is simultaneously applied to all the groups G which exist in the light emission element arrangement area B. That is, the light emission pattern is applied not only to the group G1 including the light emitting element 35A but also to the group G2 including the light emitting element 35K and the group G3 including the light emitting element 35K. Therefore, the light emitting elements 35A, 35K and 35L, which are disposed relatively at the same position in the respective groups G1, G2, and G3, have the same light emission timing and the same light emission period. As a result, the light emitting elements 35A, 35K and 35L simultaneously emit the lights.

As described above, although the light emitting element 35A in FIG. 6 is focused for the explanation, the same applies to all the light emitting elements 35 which exist in the light emitting element arrangement area B.

Incidentally, for convenience of explanation, FIG. 4 exemplifies the case that one group G is formed of the nine light emitting elements 35 arranged in a matrix of 3×3. In practice, however, for example, one group may be formed of e.g. 54 light emitting elements arranged in a matrix of 6×9. Nevertheless, the number of the light emitting elements which belong to one group, the arrangement of the light emitting elements which constitute one group, and the light emission pattern (pulse signal pattern) to make the light emitting elements, which belong to one group, emit the lights are desirably determined in view of the area of the display surface 21A, the ensured light intensity as the backlight, the accuracy of the position detection, the irradiation range of the light emitted from each light emitting element, and the like.

Now, each pulse signal generated by the cooperation of the pulse signal generation device 36 and the light emission time control device 37 is supplied to the modulation device 38.

The modulation device 38 modulates the light emitted from each light emitting element 35 by using the position information which indicates the position in the display surface 21A corresponding to the position of the light emitting element 35. Specifically, the modulation device 38 specifies the light emitting element 35 corresponding to one pulse signal generated by the cooperation of the pulse signal generation device 36 and the light emission time control device 37, and reads the position information corresponding to the position of the light emitting element 35 from the position information table TBL1. Then, the modulation device 38 modulates an on-pulse portion of the pulse signal by using the position information read from the position information table TBL1. The modulation device 38 performs such a modulation process on the plurality of pulse signals corresponding to the respective plurality of light emitting elements 35 arranged in the light emitting element arrangement area B.

The modulation process of the modulation device 38 will be explained more specifically. When a pulse signal S1 shown in FIG. 10 is inputted to the modulation device 38, the modulation device 38 reads position information P11 corresponding to the position (C1, L1) of the light emitting element 35A shown in FIG. 6 from the position information table TBL1 (refer to FIG. 8). Then, the modulation device 38, as shown in FIG. 10, modulates the on-pulse portion of the pulse signal S1 by using the position information P11. Then, when a pulse signal S2 is inputted to the modulation device 38, the modulation device 38 reads position information P12 corresponding to the position (C2, L1) of the light emitting element 35B from the position information table TBL1. Then, the modulation device 38, as shown in FIG. 10, modulates the on-pulse portion of the pulse signal S2 by using the position information P12. In the same manner, the modulation device 38 modulates a pulse signal S3 by using position information P13, modulates pulse signals S4 to S6 by using position information P21 to P23, and modulates pulse signals S7 to S9 by using position information P31 to P33, respectively.

Each of the modulated pulse signals is supplied to each light emitting element 35 of the backlight apparatus main body 31. By this, each light emitting element 35 emits the light modulated by using the position information which indicates the position in the display surface 21A corresponding to the position of the light emitting element 35. That is, each light emitting element 35 transmits the position information which indicates the position in the display surface 21AS, with the self-emitting light as a medium.

Incidentally, the light emitted from each light emitting element 35 is blinked by the light emission time control by the light emission time control device 37 and the modulation process of the modulation device 38. However, since a blinking speed is high speed (e.g. the lowest frequency is 100 kHz or more), the backlight does not flick.

Moreover, the light emitted from each light emitting element 35 is modulated by using the position information in the modulation process of the modulation device 38. Thus, it can be considered that the light intensity of the light emitted from each light emitting element 35 may vary depending on the content of the position information. Thus, if the position information is formed of binary data, the position information is desirably formed so that the number of “1” and the number of “0” in all the position information are equal to each other. By this, it is possible to prevent the light intensity of the light emitted from each light emitting element 35, from varying because of the modulation.

As explained above, the backlight apparatus 3 modulates the backlight by using the position information which indicates the position in the display surface 21A and transmits the position information in the display surface 21A. Therefore, according to the backlight apparatus 3, it is possible to realize the position detection in the display surface 21A by using the backlight. Then, according to the backlight apparatus 3, it is possible to realize the position detection in the display surface 21A without adding exclusive hardware for detecting the position in the display surface 21A to the liquid crystal display apparatus. Thus, it is possible to realize the simplification of the hardware structure of the display apparatus, a reduction in costs, a reduction in a size, or a reduction in restrictions on the setting and design, while realizing the position detection in the display screen 21A.

Moreover, according to the backlight apparatus 3, it is possible to realize the position detection in the display screen 21A without reducing the visibility of the display screen 21A and without reducing the durability of the display apparatus.

Moreover, the backlight apparatus 3 varies the light emission timing of each of the light emitting elements 35 which belong to the same group G and sets the light emission period so that the lights emitted from the light emitting elements 35 do not overlap (refer to FIG. 10). This allows the position information included in the light emitted from each light emitting element 35 to be identified easily and highly accurately, and also allows the position information to be surely extracted from the light emitted from each light emitting element 35, on the light receiving apparatus 4. Therefore, it is possible to increase the accuracy of the position detection.

Moreover, according to the backlight apparatus 3, the light emitting elements 35 arranged in the light emitting element arrangement area B are divided into many groups G, and the light emission time control is simultaneously performed by using the same light emission pattern for each group G, to thereby make the light emitting elements 35 without the irradiation ranges R overlapping emit the lights simultaneously. By this, as shown in FIG. 10, it is possible to prolong the light emission period LP of the individual light emitting element 35. Therefore, it is possible to realize the backlight without flickering and to certainly transmit the position information.

That is, if the cycle of the light emission pattern applied to each group G is CY and the number of the light emitting elements 35 which belong to one group G is N, the light emission period LP of the individual light emitting element 35 is

LP=CY÷N.

In this case, as the light emitting elements 35 arranged in the light emitting element arrangement area B are divided into more groups G to reduce the number of the light emitting elements 35 which belong to each group G, the light emission period LP of the individual light emitting element 35 becomes longer. Then, by prolonging the light emission period LP of the individual light emitting element 35, it is possible to reduce or resolve the flickering of the backlight. Moreover, if the light emission period LP of the individual light emitting element 35 becomes longer, it is possible to repeatedly transmit the same position information in one light emission period LP. Thus, it is possible to increase the certainty of the transmission of the position information.

Moreover, according to the backlight apparatus 3, the light emitting elements 35 arranged in the light emitting element arrangement area B are divided into more groups G, and the light emission time control is simultaneously performed by using the same light emission pattern for each group G, to thereby make the light emitting elements 35 without the irradiation ranges R overlapping emit the lights simultaneously. By this, as shown in FIG. 10, it is possible to shorten the cycle CY of the light emission pattern applied to each group G. Therefore, it is possible to realize the backlight without flickering and to certainly transmit the position information.

That is, if the number of the light emitting elements 35 which belong to one group G is N and the light emission period of the individual light emitting element 35 is LP, the cycle CY of the light emission pattern is

CY=N×LP

In this case, as the light emitting elements 35 arranged in the light emitting element arrangement area B are divided into more groups G to reduce the number of the light emitting elements 35 which belong to each group G, the cycle CY of the light emission pattern becomes shorter. Then, shorting the cycle CY of the light emission pattern allows the light emission period of each light emitting element 35 to be shorten. Thus, it is possible to prevent the backlight from flickering. Moreover, shortening the cycle CY of the light emission pattern allows an increase in the number of times of transmission of the position information by the light emission of each light emitting element 35. Thus, it is possible to repeatedly transmit the same position information and to increase the certainty of the transmission of the position information.

Incidentally, the backlight apparatus 3 modulates the light emitted from each light emitting element 35 by using the position information which indicates the position in the display surface 21A corresponding to the position of the light emitting element 35. In the aforementioned explanation, the position information is set for each individual light emitting element 35, as shown in FIG. 6. The present invention, however, is not limited to this. For example, one piece of position information may be provided for each group G. In this case, the light receiving apparatus 4 detects the position in the display surface 21A, on the basis of the position information obtained by the demodulation and the light reception timing of the light emitted from the light emitting element 35. That is, the light receiving apparatus 4 specifies one group G on the basis of the position information and specifies one light emitting element 35 which belongs to the group G on the basis of the light reception timing.

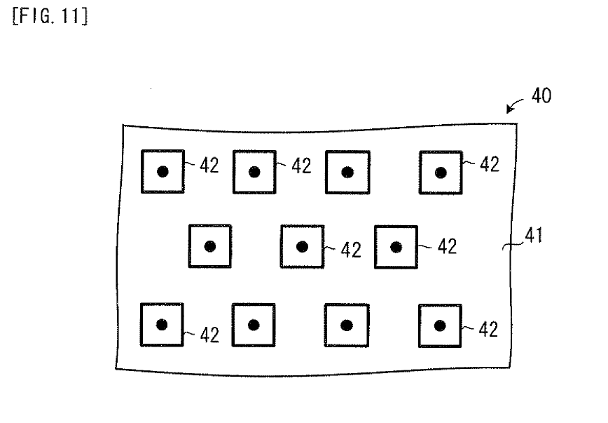

Moreover, on the backlight apparatus 3, the light emitting elements 35 are arranged in a matrix in the light emitting element arrangement area B; however, as in a backlight apparatus 40 shown in FIG. 11, light emitting elements 42 may be arranged in a staggered shape in a light emitting element arrangement area on a support substrate 41.

(Backlight Apparatus 2)

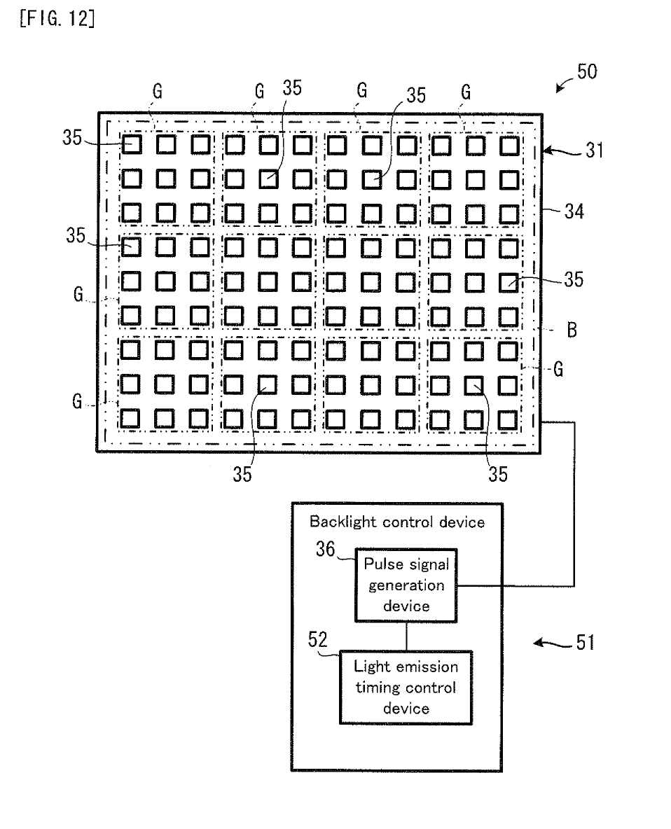

FIG. 12 shows another form of the backlight apparatus. In a backlight apparatus 50 shown in FIG. 12, the light emission timing of each of the light emitting elements 35 arranged in the light emitting element arrangement area B varies depending on the position of the light emitting element 35. That is, the backlight apparatus 50 does not modulate the light emitted from each light emitting element 35 by using the position information. Moreover, the light receiving apparatus 4 detects the position in the display surface 21A on the basis of the light emission timing of each light emitting element 35. Incidentally, in the backlight apparatus 50 in FIG. 12, the same constituent elements as those of the backlight apparatus 3 in FIG. 4 carry the same numerical references and the explanation thereof will be omitted.

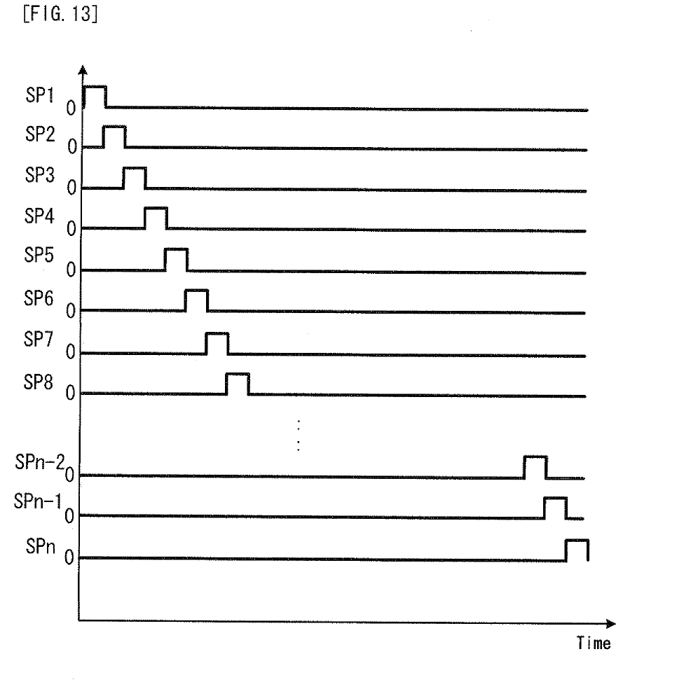

As shown in FIG. 12, a backlight control device 51 of a backlight apparatus 50 is provided with a light emission timing control device 52. The light emission timing control device 52 varies the light emission timing of each light emitting element 35 depending on the position of the light emitting element 35. Incidentally, the light emission period of each light emitting element 35 is desirably set so that the lights emitted from the light emitting elements 35 do not overlap. For example, under the control of the light emission timing control device 52, pulse signals SP1 to SPn shown in FIG. 13 are outputted from a pulse signal generation device 26. The pulse signals SP1 to SPn are supplied to the respective light emitting elements 35, by which the light emitting elements 35 emit the lights in respective different light emission timing.

As explained above, according to the backlight apparatus 50, it is possible to transmit the position in the display surface 21A by using the backlight and to realize the position detection in the display surface 21A. Moreover, according to the backlight apparatus 50, it is possible to realize the position detection in the display surface 21A without adding exclusive hardware for detecting the position in the display surface 21A to the display apparatus. Thus, it is possible to realize the simplification of the hardware structure of the display apparatus, a reduction in costs, a reduction in a size, or a reduction in restrictions on the setting and design, while realizing the position detection in the display screen 21A.

Moreover, according to the backlight apparatus 50, it is possible to realize the position detection in the display screen 21A without reducing the visibility of the display screen 21A and without reducing the durability of the display apparatus.

Moreover, in the backlight apparatus 50, the position detection in the display surface 21A is performed only by varying the light emission timing of each light emitting element 35. Therefore, the position detection can be realized in a simpler structure than that of the backlight apparatus 3. The position detection in the screen can be realized in a simple structure by applying the backlight apparatus 50 to a display apparatus with a small screen, such as a high-functional mobile phone, which can contribute to a reduction in size of the high-functional mobile phone or the like, or a reduction in cost.

(Backlight Apparatus 3)

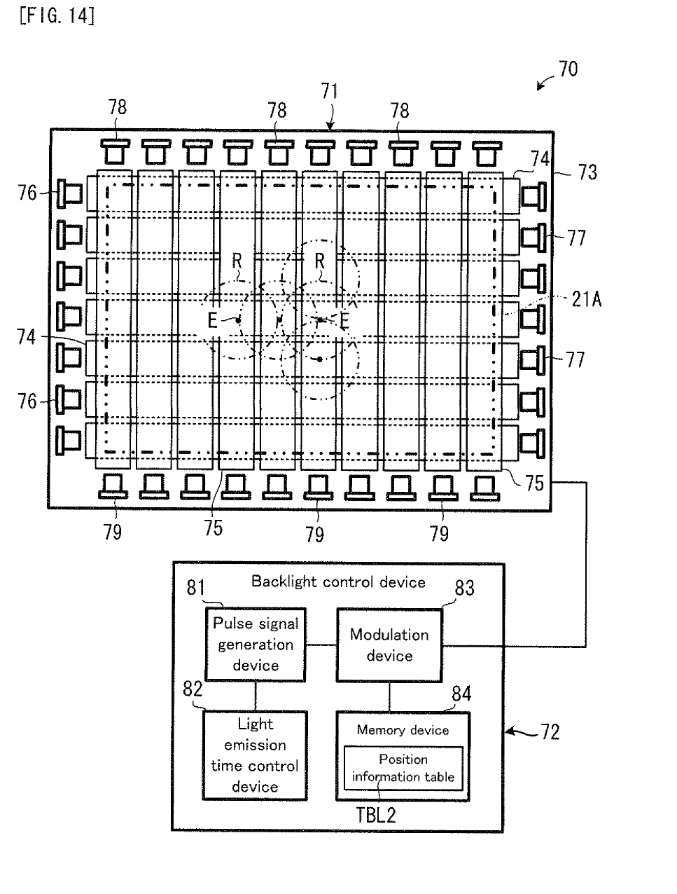

FIG. 14 shows another form of the backlight apparatus. In a backlight apparatus 70 shown in FIG. 14, the light emitting elements are arranged in the surroundings of the display surface 21A, and the lights emitted from the light emitting elements are lead to the rear of the display surface 21A by using light guide members.

That is, a backlight apparatus 70 in FIG. 14 is provided with: a backlight apparatus main body 71; and a backlight control device 72.

The backlight apparatus main body 71 has a support substrate 73. On the support substrate 73, light guide members 74 and 75 are provided in an area spread in the rear of the display surface 21A. In the surroundings of the display surface 21A, there are a plurality of light emitting elements 76, 77, 78, and 79 disposed. Each of the light emitting elements 76 to 79 is, for example, a white light emitting diode. Moreover, the light emitting elements 76 to 79 are arranged on the rear side of the display surface 21A in the depth direction of the liquid crystal display apparatus and are arranged such that the positions of the light emitting elements 76 to 79 substantially match the positions of the light guide members 74 and 75 in the depth direction of the backlight apparatus 70. Moreover, the light guide member 74 guides the light emitted from each of the light emitting elements 76 and 77 in a row direction and guides the light to the rear of the display surface 21A. Moreover, the light guide member 75 guides the light emitted from each of the light emitting elements 78 and 79 in a column direction and guides the light to the rear of the display surface 21A. Moreover, an intersection between the optical axis of the light emitted from each of the light emitting elements 76 and 77 and the optical axis of the light emitted from each of the light emitting elements 78 and 79, or an intersection of the light guide members 74 and 75, is the light emitting point E.

On the other hand, the backlight control device 72 is provided with: a pulse signal generation device 81; a light emission time control device 82; a modulation device 83; and a memory device 84. The pulse signal generation device 81 is provided with e.g. a pulse signal generation circuit. The light emission time control device 82 is provided with e.g. a signal processing circuit. The modulation device 83 is provided with e.g. a modulation circuit. The memory device 84 is provided with e.g. a semiconductor memory apparatus, such as a ROM.

The memory device 84 stores therein a position information table TBL2. The position information table TBL2 is a table describing row position information about each of the light emitting elements 76 and 77 and column position information about each of the light emitting elements 78 and 79. For example, each of the row position information and the column position information is binary data. Incidentally, in the embodiment, the modulation is performed by using the same row position information with regard to the light emitting elements 76 and 77 facing each other. Thus, the position information table TBL2 describes the same row position information with regard to the light emitting elements 76 and 77 facing each other. Moreover, the modulation is performed by using the same column position information with regard to the light emitting elements 78 and 79 facing each other. Thus, the position information table TBL2 describes the same column position information with regard to the light emitting elements 78 and 79 facing each other.

The backlight control device 72 operates, for example, as follows. Firstly, the pulse signal generation device 81 generates a pulse signal to control the light emission of each of the light emitting elements 76 to 79. The pulse signal is generated for each of the light emitting elements 76 to 79.

When the pulse signal generation device 81 generates the pulse signal, the light emission time control device 82 controls the light emission timing and the light emission period of each of the light emitting elements 76 to 79 so that the lights emitted from the light emitting elements 76 to 79 do not overlap. Specifically, the light emission time control device 82 controls the light emission time control device 81, to thereby control the rising timing and the pulse width of each pulse signal generated by the pulse signal generation device 81.

The light emission time control by the light emission time control device 82 will be explained more specifically. In the backlight apparatus 70, the irradiation ranges R of the light emitting points do not overlap, as shown in FIG. 14, between odd-number rows, between even-number rows, between odd-number columns, and between even-number columns. Moreover, the light emitting elements 76 and 77 facing each other emit the lights in the same light emission timing and have the same light emission period. Moreover, the light emitting elements 78 and 79 facing each other emit the lights in the same light emission timing and have the same light emission period.

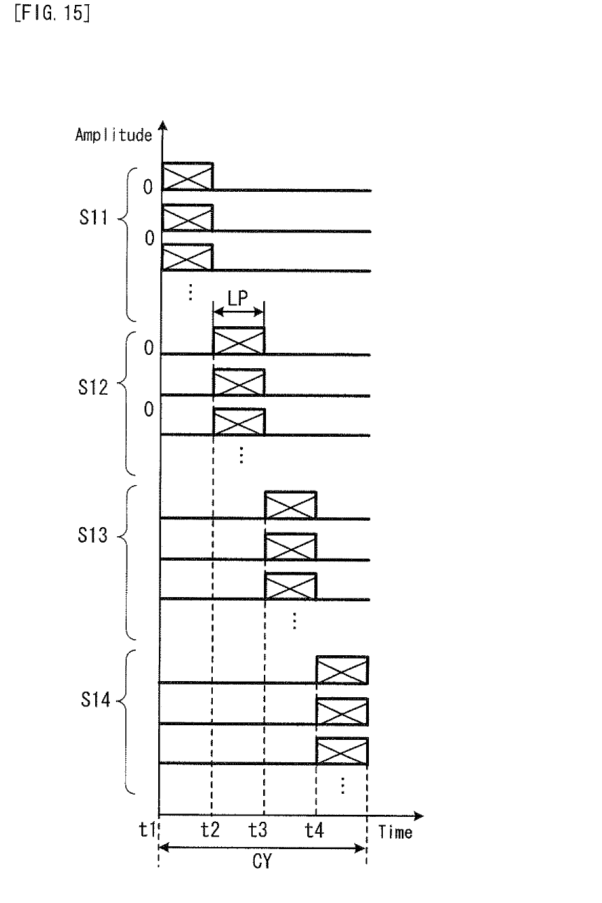

Under this condition, the light emission time control device 82 firstly makes those arranged in the odd-number rows of the light emitting elements 76 and 77, emit the lights. Then, the light emission time control device 82 makes those arranged in the odd-number columns of the light emitting elements 78 and 78, emit the lights. Then, the light emission time control device 82 makes those arranged in the even-number rows of the light emitting elements 76 and 77, emit the lights. Then, the light emission time control device 82 makes those arranged in the even-number columns of the light emitting elements 78 and 79, emit the lights. Specifically, the light emission time control device 82 controls the pulse signal generation device 81 to generate four types of pulse signals S11, S12, S13, S14 to be supplied to each of the light emitting elements 76 and 77 in the odd-number rows, the light emitting elements 78 and 79 in the odd-number columns, the light emitting elements 76 and 77 in the even-number rows, and the light emitting elements 78 and 79 in the even-number columns, as shown in FIG. 15.

Each pulse signal generated by the cooperation by the cooperation of the pulse signal generation device 81 and the light emission tinle control device 82 is supplied to the modulation device 83.

The modulation device 83 modulates the light emitted from each of the light emitting elements 76 and 77 by using the row position information which indicates the row position of each of the light emitting elements 76 and 77. Specifically, the modulation device 83 specifies the light emitting elements 76 and 77 (the light emitting elements 76 and 77 facing each other) corresponding to one pulse signal generated by the cooperation of the pulse signal generation device 81 and the light emission time control device 82, and reads the row position information corresponding to the row position of each of the light emitting elements 76 and 77 from the position information table TBL2. Then, the modulation device 83 modulates the on-pulse portion of the pulse signal by using the row position information read from the position information table TBL2. The modulation device 83 performs such a modulation process on the pulse signals corresponding to the other light emitting elements 76 and 77.

Moreover, the modulation device 83 modulates the light emitted from each of the light emitting elements 78 and 79 by using the column position information which indicates the column position of each of the light emitting elements 78 and 79. Specifically, the modulation device 83 specifies the light emitting elements 78 and 79 (the light emitting elements 78 and 79 facing each other) corresponding to one pulse signal generated by the cooperation of the pulse signal generation device 81 and the light emission time control device 82, and reads the column position information corresponding to the column position of each of the light emitting elements 78 and 79 from the position information table TBL2. Then, the modulation device 83 modulates the on-pulse portion of the pulse signal by using the column position information read from the position information table TBL2. The modulation device 83 performs such a modulation process on the pulse signals corresponding to the other light emitting elements 78 and 79.

Each of the modulated pulse signals is supplied to each of the light emitting elements 76 to 79 of the backlight apparatus main body 71. By this, each of the light emitting elements 76 and 77 emits the light modulated by using the row position information which indicates the row position of each of the light emitting elements 76 and 77. Moreover, each of the light emitting elements 78 and 79 emits the light modulated by using the column position information which indicates the column position of each of the light emitting elements 78 and 79. As a result, the light emitted from each light emitting point E is the light sequentially modulated using the row position information and the column position information which indicate the position in the display surface 21A corresponding to the position of the light emitting point E. That is, each light emitting point E essentially transmits the position information which indicates the position of one point in the display surface 21A by sequentially transmitting the row position information and the column position information which indicate the position in the display surface 21A corresponding to the position of the light emitting point E.

As explained above, the backlight apparatus 70 modulates the backlight by using the position information (the row position information+the column position information) which indicates the position in the display surface 21A, to thereby transmit the position information in the display surface 21A. Therefore, according to the backlight apparatus 70, it is possible to realize the position detection in the display surface 21A by using the backlight. Then, according to the backlight apparatus 70, it is possible to realize the position detection in the display surface 21A without adding exclusive hardware for detecting the position in the display surface 21A to the liquid crystal display apparatus. Thus, it is possible to realize the simplification of the hardware structure of the display apparatus, a reduction in costs, a reduction in a size, or a reduction in restrictions on the setting and design, while realizing the position detection in the display screen 21A.

Moreover, according to the backlight apparatus 70, it is possible to realize the position detection in the display screen 21A without reducing the visibility of the display screen 21A and without reducing the durability of the liquid crystal display apparatus.

Moreover, the backlight apparatus 70 varies the light emission timing of each of the light emitting elements 76 and 77 in the odd-number rows, the light emitting elements 78 and 79 in the odd-number columns, the light emitting elements 76 and 77 in the even-number rows, and the light emitting elements 78 and 79 in the even-number columns and sets the light emission period so that the lights emitted from the light emitting elements 76 to 79 with the irradiation ranges R overlapping do not overlap (refer to FIG. 15). This allows the row position information and the column position information included in the light emitted from each of the light emitting elements 76 to 79 to be identified easily and highly accurately, and also allows the row position information and the column position information to be surely extracted from the light emitted from each of the light emitting elements 76 to 79, on the light receiving apparatus 4. Therefore, it is possible to increase the accuracy of the position detection.

Moreover, according to the backlight apparatus 70, it makes the light emitting elements 76 and 77 in the odd-number rows simultaneously emit the lights, the light emitting elements 78 and 79 in the odd-number columns simultaneously emit the lights, the light emitting elements 76 and 77 in the even-number rows simultaneously emit the lights, and the light emitting elements 78 and 79 in the even-number columns simultaneously emit the lights. By this, as shown in FIG. 15, it is possible to prolong the light emission period LP of the individual light emitting element 35. Alternatively, it is possible to shorten the cycle CY of the light emission pattern applied to each group G. Therefore, it is possible to realize the backlight without flickering and to certainly transmit the position information.

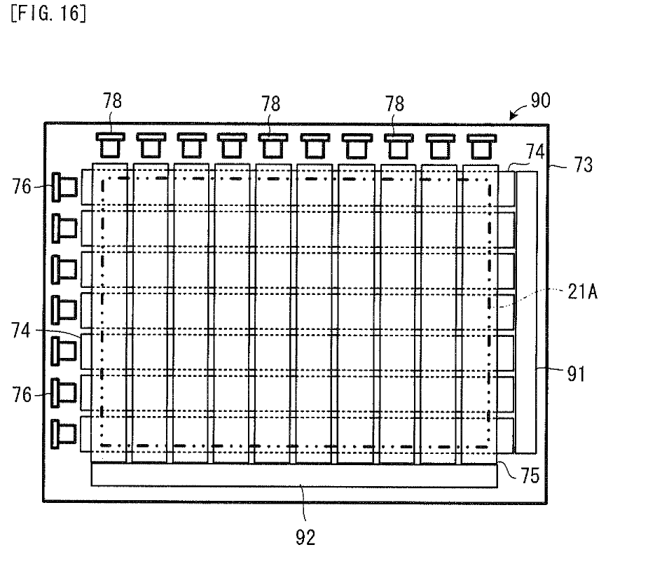

Incidentally, on the backlight apparatus main body 71, the light emitting elements 76 to 79 are disposed on the both sides in the row direction and the both sides in the column direction of the display surface 21A. The present invention, however, is not limited to this. For example, as shown in a backlight apparatus main body 90 in FIG. 16, the light emitting elements 76 may be disposed on one side in the row direction of the display surface 21A, a reflective member may be disposed on the other side in the row direction of the display surface 21A, the light emitting elements 78 may be disposed on one side in the column direction of the display surface 21A, and a reflective member 92 may be disposed on the other side in the column direction of the display surface.

(Light Receiving Apparatus)

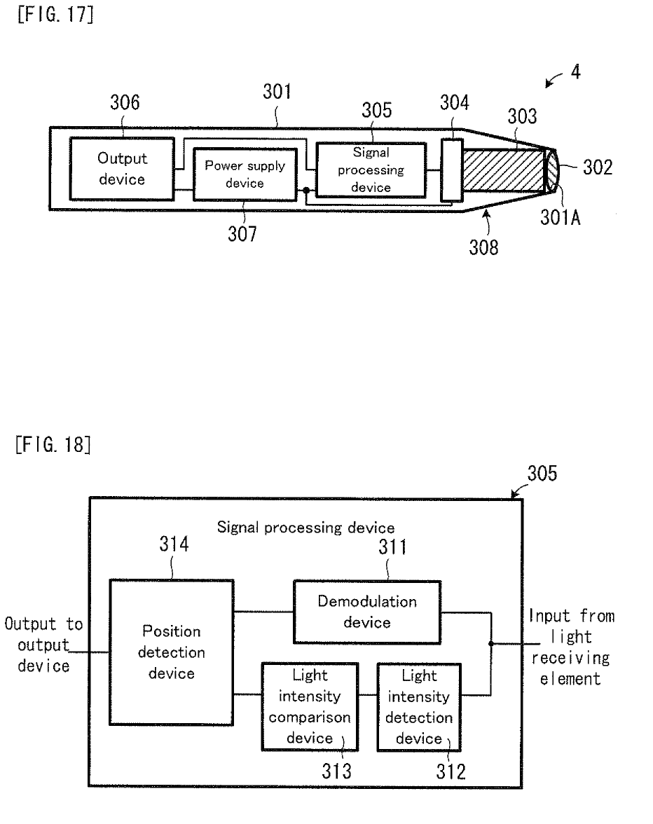

FIG. 17 shows the structure of the light receiving apparatus 4 in FIG. 1. As shown in FIG. 17, the light receiving apparatus 4 is provided with: a case 301; a lens 302; a light guide member 303; a light receiving element 304; a signal processing device 305; an output device 306; and a power supply device 307.

The case 301 has, for example, a cylinder shape, a tapered tip portion, and a pen-shaped overall outer form. Moreover, the case 301 is formed, for example, of a resin material or a light metal material, such as aluminum. Moreover, the case 301 accommodates the lens 302; the light guide member 303; the light receiving element 304; the signal processing device 305; the output device 306; and the power supply device 307. Furthermore, the case 301 has a hole 301A in the tip portion to transmit the light through the lens 302 from the exterior.

The lens 302 focuses the light, which is emitted from the light receiving element 35 and on which the modulation process or the like is performed by the backlight control device 32, on the light receiving surface of the light receiving element 304. The lens 302 is located in the tie portion of the light receiving apparatus 4 and is mounted within the hole 301A. The light guide member 303 guides the light which enters the lens 302 to the light receiving element 304. The light guide member 303 is disposed between the lens 302 and the light receiving element 304. The light receiving element 304 converts the light guided to the light receiving surface, to an electric signal (hereinafter referred to as a “light detection signal”) and outputs it to the signal processing device 305.

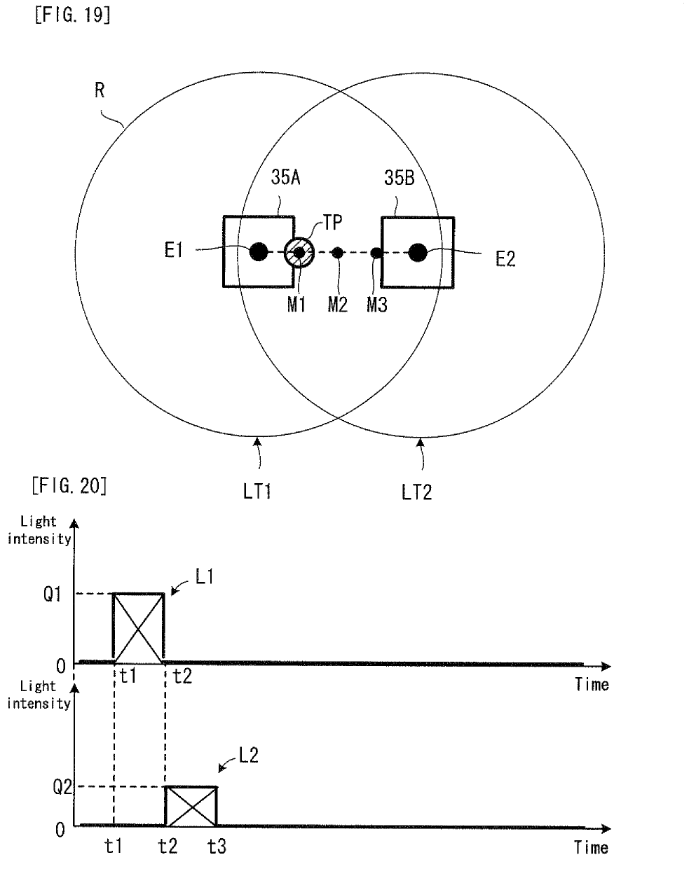

The lens 302, the light guide member 303, and the light receiving element 304 constitute a light receiving system 308. A range of receiving the light emitted from the light receiving element 35 by the light receiving system 308 (a light receiving range) is less than the irradiation range R of the light emitting element 35. For example, the light receiving range is a small circle expressed by a reference TP (a circle with hatching drawn) in FIG. 19. Thus, the light which enters the light receiving apparatus 4 at a time is one portion of the light emitted from the light emitting element 35.

The signal processing device 305 performs demodulation, light-intensity detection, light-intensity comparison, position detection, and the like on the light detection signal outputted from the light receiving element 304, and outputs precise position information which indicates a precise position in the display surface 21A. The structure of the signal processing device 305 will be explained later.

The output device 306 transmits the precise position information, outputted from the signal processing device 305, on a carrier wave, such as an electric wave and a ray of light, to the computer 5. The output device 306 is desirably provided with a wireless communication circuit or the like. For example, the output device 306 desirably employs a wireless communication technology, such as Bluetooth.

The power supply device 307 supplies an electric power to drive the light receiving element 304, the signal processing device 305, the output device 306, and the like. The power supply device 307 can be formed, for example, of an electric double layer capacitor, a battery cell, or the like.

FIG. 18 shows the structure of the signal processing device 305. The signal processing device 305 is provided with: a demodulation device 311; a light intensity detection device 312; a light intensity comparison device 313; and a position detection device 314.

The demodulation device 311 demodulates the light received by the light receiving system 308, to thereby obtain the position information included in the light emitted from the light emitting element 35. Specifically, the demodulation device 311 demodulates the light detection signal outputted from the light receiving element 304, and extracts the position information included in the light detection signal. The demodulation circuit 311 is provided with e.g. a demodulation circuit.

The light intensity detection device 312 detects the light intensity of the light outputted from the light receiving element 304. Specifically, the light intensity detection device 312 detects an integral value per predetermined period of the amplitude of the light detection signal outputted from the light receiving element 304, an average value, a maximum value of an instant value in the predetermined period, or the like. For example, if the position information which allows the light emitted from the light emitting element 35 to be modulated is binary data and this position information is formed such that the number “1” and the number of “0” are equal to each other, the light intensity detection device 312 desirably detects the integral value or the average value per certain period of the amplitude of the light detection signal outputted from the light receiving element 304.

The light intensity comparison device 313 compares the light intensity of a plurality of lights detected by the light intensity detection device 312. The light intensity comparison device 313 is provided with e.g. a signal processing circuit including a comparison circuit.

The position detection device 314 detects the precise position in the display surface 21A on the basis of a result of the comparison by the light intensity comparison device 313 and the position information obtained by the demodulation device, and generates the precise position information indicating the precise position. The generated precise position information is outputted to the output device 306.

With reference to FIG. 19 and FIG. 20, the operation of the light receiving apparatus 4 will be explained. FIG. 19 shows the two light receiving elements 35A and 35B of the many light receiving elements 35 arranged in the light emitting element arrangement area B of the backlight apparatus 3. FIG. 20 shows the light intensity of the lights emitted from the two light receiving elements 35A and 35B. Incidentally, the explanation below exemplifies the case that the light receiving apparatus 4 sequentially receives the lights LT1 and LT2 emitted from the two light receiving elements 35A and 35B. In practice, as can be seen from the overlap of the irradiation ranges R of the light emitting elements 35 shown in FIG. 6, the light receiving apparatus 4 sequentially receives the lights emitted from the two or more light emitting elements 35, and the operation principle is the same as in the case that the light receiving apparatus 4 sequentially receives the lights LT1 and LT2 emitted from the two light receiving elements 35A and 35B.

A user holds the light receiving apparatus 4 with the hand and contacts the tip portion of the light receiving apparatus 4 on the display surface 21A of the liquid crystal panel apparatus 2. For example, when the tip portion of the light receiving apparatus 4 comes into contact with the display surface 21A in this manner, the light receiving apparatus 4 starts a process of detecting the contact position between the tip portion of the light receiving apparatus 4 and the display surface 21A.

As shown in FIG. 19, it is assumed that the contact position between the tip portion of the light receiving apparatus 4 and the display surface 21A is between the light receiving elements 35A and 35B (between the light emitting points E1 and E2) and that the contact position is a position TP which is closer to the light emitting element 35A than to the light emitting element 35B. The irradiation range R of the light emitting element 35A overlaps the irradiation range R of the light emitting element 35B, and the contact position TP is within the irradiation ranges R of the light receiving elements 35A and 35B. Thus, the light LT1 emitted from the light emitting element 35A and the light LT2 emitted from the light emitting element 35B sequentially enter the lens 302 of the light receiving apparatus 4. Incidentally, although the irradiation ranges R of the light receiving elements 35A and 35B overlap, the light emission timings t1 and t2 of the lights LT1 and LT2 emitted from the light receiving elements 35A and 35B, respectively, are different because of the light emission time control of the light emission time control device 37 (refer to FIG. 10 and FIG. 20). Thus, the lights LT1 and LT2 do not simultaneously enter the lens 302.

The lights LT1 and LT2 which enter the lens 302 are sequentially focused on the light receiving surface of the light receiving element 304 through the light guide member 303. In this manner, the light receiving element 304 sequentially receives the lights LT1 and LT2. Then, the light receiving element 304 converts the received lights LT1 and LT2 to the light detection signals, and outputs the light detection signals to the demodulation device 311 and the light intensity detection device 312.

The demodulation device 311 demodulates the light detection signals. Then, the demodulation device 311 extracts the position information which indicates the position in the display surface 21A corresponding to the position of the light emitting element 35A (light emitting point E1) and the position information which indicates the position in the display surface 21A corresponding to the position of the light emitting element 35B (light emitting point E2), from the light detection signals. As shown in FIG. 20, since the light emission timings t1 and t2 of the light emitting elements 35A and 35B are different from each other, the demodulation device 311 can clearly distinguish between the position information corresponding to the light emitting element 35A and the position information corresponding to the light emitting element 35B, and can extract two pieces of the position information from the light detection signals, easily and highly accurately. Then, the demodulation circuit 311 outputs the two pieces of the position information, extracted from the light detection signals, to the position detection device 314.

On the other hand, the light intensity detection device 312 detects the light intensity Q1 of the light LT1 and the light intensity Q2 of the light LT2. That is, the light intensity detection device 312 detects the average value of the amplitude of the light detection signal from the time point t1 to immediately before the time point t2, and then detects the average value of the amplitude of the light detection signal from the time point t2 to immediately before a time point t3.

Then, the light intensity comparison device 313 compares the light intensity Q1 of the light LT1 and the light intensity Q2 of the light LT2. Specifically, the light intensity comparison device 313 compares the two amplitude average values detected by the light intensity detection device 312.

Now, with reference to FIG. 19, it is considered how the light intensity Q1 and Q2 of the lights LT1 and LT2 detected by the light intensity detection device 312 will vary depending on the contact position between the light receiving apparatus 4 and the display surface 21A. For example, if the contact position is directly above the light emitting element 35A (light emitting point E1), the light intensity Q1 is significantly greater than the light intensity Q2 (Q1>>Q2). If the contact position is between the light emitting elements 35A and 35B and is at a position M1, which is closer to the light emitting element 35A than to the light emitting element 35B, the light intensity Q1 is slightly greater than the light intensity Q2 (Q1>Q2). If the contact position is at a position M2, midway between the light emitting elements 35A and 35B, the light intensity Q1 is equal to the light intensity Q2 (Q1=Q2). If the contact position is between the light emitting elements 35A and 35B and is at a position M1, which is closer to the light emitting element 35B than to the light emitting element 35A, the light intensity Q2 is slightly greater than the light intensity Q1(Q1<Q2). If the contact position is directly above the light emitting element 35B (light emitting point E2), the light intensity Q2 is significantly greater than the light intensity Q1 (Q<<Q2).

The light intensity comparison device 313 compares the light intensity Q1 and Q2 (specifically, average amplitude value), obtains any of the following five types of comparison results:

Q1>>Q2,

Q1>Q2,

Q1=Q2,

Q1<Q2,

Q1<<Q2,

and outputs the comparison example to the position detection device 314. In the example shown in FIG. 19 and FIG. 20, the contact position TP is between the light emitting elements 35A and 35B and is closer to the light emitting element 35A than to the light emitting element 35B, so that the light intensity Q1 is slightly greater than the light intensity Q2. In this case, the light intensity comparison device 313 outputs the comparison result indicating Q1>Q2, to the position detection device 3143.

The position detection device 314 detects the precise position in the display surface 21A on the basis of the result of the comparison by the light intensity comparison device 313 and the two pieces of the position information obtained by the demodulation device 311 (i.e. the position information corresponding to the light emitting element 35A and the position information corresponding to the light emitting element 35B). Moreover, the position detection device 314 generates the precise position information indicating the precise position.

The precise position is a position which is more precise than that of the light emitting element 35 (light emitting point). For example, in FIG. 19, if the position of the light emitting element 35A is coordinates (1,1) and the position of the light emitting element 35B is coordinates (1,2), the precise position is, for example, (1, 0.25), (1, 0.5), and (1, 0.75).

Now, an explanation is given on the position detection process of the position detection device 314 when the comparison result obtained from the light intensity comparison device 313 is any of the aforementioned five types of comparison results.

If the comparison result is Q1>>Q2, the position detection device 314 refers to the position information corresponding to the light emitting element 35A. Then, the position detection device 314 specifies the position in the display surface 21A corresponding to the position of the light emitting element 35A (light emitting point E1), and generates the precise position information which indicates this position (e.g. a coordinate value).

If the comparison result is Q1>Q2, the position detection device 314 refers to both the position information corresponding to the light emitting element 35A and the position information corresponding to the light emitting element 35B. Then, the position detection device 314 specifies the position M1, which is between the light emitting elements 35A and 35B and which is closer to the light emitting element 35A than to the light emitting element 35B, and generates the precise position information which indicates this position.

If the comparison result is Q1=Q2, the position detection device 314 refers to both the position information corresponding to the light emitting element 35A and the position information corresponding to the light emitting element 35B. Then, the position detection device 314 specifies the position M2, which is midway between the light emitting elements 35A and 35B, and generates the precise position information which indicates this position.

If the comparison result is Q1<Q2, the position detection device 314 refers to both the position information corresponding to the light emitting element 35A and the position information corresponding to the light emitting element 35B. Then, the position detection device 314 specifies a position M3, which is between the light emitting elements 35A and 35B and which is closer to the light emitting element 35B than to the light emitting element 35A, and generates the precise position information which indicates this position.

If the comparison result is Q1<<Q2, the position detection device 314 refers to the position information corresponding to the light emitting element 35B. Then, the position detection device 314 specifies the position in the display surface 21A corresponding to the position of the light emitting element 35B (light emitting point E2), and generates the precise position information which indicates this position.

In the example shown in FIG. 19 and FIG. 20, the comparison result shows Q1>Q2. Thus, the position detection device 314 refers to both the position information corresponding to the light emitting element 35A and the position information corresponding to the light emitting element 35B, specifies the position M1, and generates the precise position information which indicates this position. Then, the position detection device 314 outputs the precise position information to the output device 306.

Then, the output device 306 transmits the precise position information on the carrier wave to the computer 5. The computer 5 receives the precise position information, and specifies the contact position TP on the basis of the precise position information.

As explained above, according to the light receiving apparatus 4, it is possible to realize the position detection in the display surface 21A by using the backlight of the backlight apparatus 3.

Moreover, the light receiving apparatus 4 obtains the position information included in the light by demodulating the light emitted from the light emitting element 35, and specifies the position in the display surface 21A on the basis of the position information. This allows the position in the display surface 21A to be specified, easily and highly accurately.

Moreover, the light receiving apparatus 4 sequentially receives the lights emitted from the plurality of light emitting elements 35 with the irradiation ranges R overlapping, and compares the light intensity of the lights to thereby specify the precise positions. The precise position is more precise than the position of the light emitting element 35 (light emitting point). For example, in FIG. 1, if the position of the light emitting element 35A is coordinates (1, 1) and the position of the light emitting element 35B is coordinates (1,2), the precise position of the contact position TP is coordinates (1, 0.25). As described above, according to the light receiving apparatus 4, it is possible to increase the accuracy of detecting the position on the display surface 21A by specifying the precise position. For example, even if the arrangement interval of the light emitting elements 35 is large because the number of the light emitting elements 35 is less than the number of pixels, it is possible to increase the accuracy of detecting the position in the display surface 21A by specifying the precise position with the light receiving apparatus 4. Moreover, by this, it is possible to reduce the number of the light emitting elements 35 on the backlight apparatus 3 while maintaining the high accuracy of detecting the position in the display surface 21A. Thus, it is possible to reduce the costs of manufacturing the backlight apparatus 3.

(Light Receiving Apparatus 2)

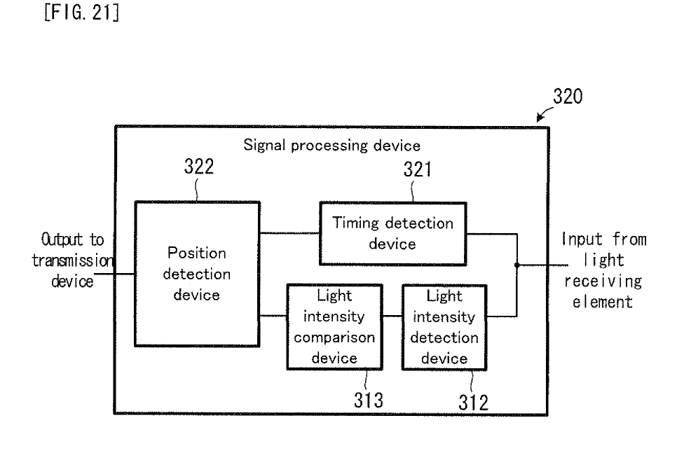

FIG. 21 shows a signal processing device of a light receiving apparatus in a second embodiment. The aforementioned light receiving apparatus in the first embodiment is used with the backlight apparatus 3 (refer to FIG. 4) of a type that transmits the position information by modulating the backlight with the position information, to thereby realize the position detection system 1. In contrast, the light receiving apparatus in the second embodiment is used with the backlight apparatus 50 (refer to FIG. 12) of a type that transmits the position in the display surface 21A only by varying the light emission timing of the backlight, to thereby realize the position detection system.

As shown in FIG. 21, the signal processing device 320 is provided with: the demodulation device 311 in FIG. 18; a timing detection device 321 instead of the position detection device 314; and a position detection device 322. The timing detection device 321 detects the position in the display surface 21A corresponding to the position of the light emitting element 35 (light emitting point E) with the irradiation range R to which the contact position belongs, on the basis of the light reception timing of the light received by the light receiving element 304, and outputs a result of the position detection to the position detection device 322. The position detection device 322 specifies the precise position in the display surface 21A with reference to the result of the position detection outputted from the timing detection device 321, substantially as in that the position detection device 314 in FIG. 18 specifies the precise position in the display surface 21A with reference to the position information.

As explained above, according to the light receiving apparatus 320, it is possible to realize the position detection in the display surface 21A by using the backlight of the backlight apparatus 50.

Moreover, the light receiving apparatus 320 performs the position detection on the basis of a difference in the light emission timing of the received light. Therefore, it is possible to realize the position detection in a simpler structure than that of the light receiving apparatus 4.

(Modified Example of Position Detection System)

In the aforementioned position detection system, it is exemplified the case that the backlight is flickered at high speed by changing ON/OFF of the light emitting element. The present invention, however, is not limited to this. By generating a light emission control signal in which the pulse signal is superimposed on a direct current signal at a predetermined level and supplying it to the light emitting element, the light emission intensity (light intensity) of each light emitting element may be changed at high speed while maintaining the light emission of the light emitting element.

Moreover, in the aforementioned position detection system, it is exemplified the case that the light emitting diode which emits visible light is used as the light emitting element; however, the light emitting diode which emits infrared light may be also used as the light emitting element with the light emitting diode which emits visible light. For example, the light emitting diode which emits visible light and the light emitting diode which emits infrared light are alternately disposed. If a black image or the like is displayed on the display surface, the light emitting diode which emits visible light and which is disposed in the display area of the black image is extinguished, and the light emitting diode which emits infrared light and which is disposed in the display area of the black image emits the light. By this, it is possible to realize the transmission of the position information in the display surface with increasing the contrast of the image.

Moreover, in order to increase the contrast of the image, the following method may be employed. That is, when the black image is displayed on the display surface, although the light emitting diode which emits visible light and which is disposed in the display area of the black image emits the light, the substantial light emission intensity of the light emitting diode is reduced by narrowing a pulse width for modulating the light emitting element.

Moreover, in the aforementioned position detection system, it is exemplified the case that the position detection is realized by modulating the backlight of the liquid crystal display apparatus. In the liquid crystal display apparatus, the visual display of information, such as a character and a figure, is performed by the cooperation of the liquid crystal display apparatus and the backlight apparatus. Moreover, the light emitting element which emits the light to the display surface is mounted on the backlight apparatus. Thus, if the position detection system of the present invention is applied to the liquid crystal display apparatus, as described above, it is desirable to modulate the light emitted from the light emitting element of the backlight apparatus, i.e. the backlight.

The position detection system of the present invention, however, can be also applied to a so-called self-emitting type display panel which is not provided with the backlight apparatus, such as a plasma display apparatus and an organic EL display apparatus. In this case, the light emission brightness of the self-emitting element, such as a plasma light emitting element and an organic EL element, is modulated to the position information which indicates the position in the display surface. Alternatively, the timing of changing the light emission brightness of the self-emitting element is varied depending on the position in the display surface.

Incidentally, in the present invention, various changes may be made, if desired, without departing from the essence or spirit of the invention which can be read from the claims and the entire specification. A display apparatus, a liquid crystal display apparatus, a position detection system and a position detection method, which involve such changes, are also intended to be within the technical scope of the present invention.

### INDUSTRIAL APPLICABILITY

The display apparatus, the liquid crystal display apparatus, the position detection system and the position detection method of the present invention can be applied to, for example, a display apparatus, such as a liquid crystal display apparatus, a plasma display apparatus, and an organic EL (Electro-luminescence) display apparatus, and more specifically, to a position detection system for detecting the position in the display surface of such a display apparatus, and further to a display apparatus having such a position detection function.

1. A display apparatus comprising; a backlight apparatus having a plurality of light emitting elements for generating a plurality of light emitting points, each of which emits light to a display surface to display information visually, said display apparatus further comprising a modulating device for modulating the light emitted from each of the light emitting points by using position information which indicates a position in the display surface corresponding to a position of the light emitting point.

2. A display apparatus comprising: a backlight apparatus having a plurality of light emitting elements for generating a plurality of light emitting points, each of which emits light to a display surface to display information visually apparatus further comprising a light emission timing control device for varying light emission timing of each of the light emitting points, depending on a position of the light emitting point.

3. The display apparatus according to claim 1, further comprising a light emission time controlling device for controlling a light emission period and light emission timing of each of the light emitting points so that the lights emitted from the plurality of light emitting points do not overlap.

4. The display apparatus according to claim 3, wherein
the plurality of light emitting points are divided into a plurality of groups, and
said light emission time controlling device has a light emission pattern which sets the light emission period and the light emission timing of the light emitting points which belong to the same group so that the lights emitted from the light emitting points which belong to the same group do not overlap, and controls the light emission of the light emitting points which belong to the same group in accordance with the emission pattern.

5. The display apparatus according to claim 4, wherein the same light emission pattern is applied to each of the groups, to thereby make the light emitting points which belong to each of the groups, emit light in accordance with the same light emission pattern.

6. The display apparatus according to claim 1 or 2, wherein the plurality of light emitting elements are disposed in a rear of the display surface, and the position of each of the light emitting elements matches the position of each of the light emitting points.

7. The display apparatus according to claim 1, wherein
said display apparatus further comprises a first light guide member and a second light guide member in a rear of the display surface,
the plurality of light emitting elements comprise a plurality of first light emitting elements and a plurality of second light emitting elements,
the plurality of first light emitting elements and the plurality of second light emitting elements are disposed in surroundings of the display surface,
the first light guide member guides first light emitted from each of the first light emitting elements to a first direction, to thereby guide the first light to the rear of the display surface,
the second light guide member guides second light emitted from each of the second light emitting elements to a second direction, which crosses the first direction, to thereby guide the second light to the rear of the display surface, and
an intersection position between each of the first lights and each of the second lights matches the position of each of the light emitting points.

8. The display apparatus according to claim 2, wherein
said display apparatus further comprises a first light guide member and a second light guide member in a rear of the display surface,
the plurality of light emitting elements comprise a plurality of first light emitting elements and a plurality of second light emitting elements,
the plurality of first light emitting elements and the plurality of second light emitting elements are disposed in surroundings of the display surface,
the first light guide member guides first light emitted from each of the first light emitting elements to a first direction, to thereby guide the first light to the rear of the display surface,
the second light guide member guides second light emitted from each of the second light emitting elements to a second direction, which crosses the first direction, to thereby guide the second light to the rear of the display surface, and
an intersection position between each of the first lights and each of the second lights matches the position of each of the light emitting points.

9. The display apparatus according to claim 1, wherein each of the light emitting elements is a light emitting diode.

10. The display apparatus according to claim 2, wherein each of the light emitting elements is a light emitting diode.

11. A liquid crystal display apparatus comprising: a liquid crystal panel apparatus in which an electrode and a liquid crystal are provided between two substrates; and a backlight apparatus for emitting light to a display surface of said liquid crystal panel apparatus,
said backlight apparatus comprising:
a plurality of light emitting elements for generating a plurality of light emitting points, each of which emits light to the display surface; and
a modulating device for modulating the light emitted from each of the light emitting points by using position information which indicates a position in the display surface corresponding to a position of the light emitting point.

12. A liquid crystal display apparatus comprising: a liquid crystal panel apparatus in which an electrode and a liquid crystal are provided between two substrates; and a backlight apparatus for emitting light to a display surface of said liquid crystal panel apparatus,
said backlight apparatus comprising:
a plurality of light emitting elements for generating a plurality of light emitting points, each of which emits light to the display surface; and
a light emission timing control device for varying light emission timing of each of the light emitting points, depending on a position of the light emitting point.

13. A position detection system for detecting a position in a display surface to display information visually, said position detection system comprising:
a backlight apparatus for emitting light to the display surface from a rear of the display surface; and
a light receiving apparatus for receiving the light emitted to the display surface, from a front side of the display surface,
said backlight apparatus comprising:
a plurality of light emitting elements for generating a plurality of light emitting points, each of which emits light to the display surface; and
a modulating device for modulating the light emitted from each of the light emitting points by using position information which indicates a position in the display surface corresponding to a position of the light emitting point,
said light receiving apparatus comprising:
a light receiving device for receiving the light, which is emitted from each of the light emitting points and which is modulated by said modulating device;
a demodulating device for demodulating the light received by said light receiving device, to thereby obtain the position information; and
an outputting device for outputting the position information obtained by said demodulating device.

14. The position detection system according to claim 13, wherein said backlight apparatus further comprises a light emission time controlling device for controlling a light emission period and light emission timing of each of the light emitting points so that the lights emitted from the plurality of light emitting points do not overlap.

15. The position detection system according to claim 14, wherein
said light receiving apparatus comprises: a light intensity detecting device; a light intensity comparing device; and a position detecting device,
said light receiving device receives a plurality of lights emitted from the plurality of light emitting points,
said light intensity detecting device detects light intensity of each of the plurality of lights received by said light receiving device,
said light intensity comparing device compares light intensity of each of the plurality of lights detected by said light intensity detecting device,
said demodulating device demodulates the plurality of lights received by said light receiving device, to thereby obtain a plurality of position information corresponding to the respective plurality of light emitting points,
said position detecting device detects a precise position in the display surface on the basis of a result of the comparison by said light intensity comparing device and the plurality of position information obtained by said demodulating device, and generates precise position information which indicates the precise position, and
said outputting device outputs the precise position information generated by said position detecting device.

16. A position detection system for detecting a position in a display surface to display information visually, said position detection system comprising:
a backlight apparatus for emitting light to the display surface from a rear of the display surface; and
a light receiving apparatus for receiving the light emitted to the display surface, from a front side of the display surface,
said backlight apparatus comprising:
a plurality of light emitting elements for generating a plurality of light emitting points, each of which emits light to the display surface; and
a light emission timing control device for varying light emission timing of each of the light emitting points, depending on a position of the light emitting point,
said light receiving apparatus comprising:
a light receiving device for receiving the light, which is emitted from each of the light emitting points;
a position detecting device for detecting the position in the display surface on the basis of light reception timing of the light received by said light receiving device and generating position information which indicates the position; and
an outputting device for outputting the position information generated by said position detecting device.

17. The position detection system according to claim 14, wherein
said light receiving apparatus comprises: a light intensity detecting device; and a light intensity comparing device,
said light receiving device receives a plurality of lights emitted from the plurality of light emitting points,
said light intensity detecting device detects light intensity of each of the plurality of lights received by said light receiving device,
said light intensity comparing device compares light intensity of each of the plurality of lights detected by said light intensity detecting device, and
said position detecting device detects a precise position in the display surface on the basis of a result of the comparison by said light intensity comparing device and the light reception timing of each of the plurality of lights received by light receiving device, and generates precise position information which indicates the precise position.

18. The position detection system according to claim 13, wherein
said light receiving apparatus comprises a pen-shaped case, and
said light receiving device is provided in a tip portion of the case.

19. A position detection method for detecting a position in a display surface to display information visually, said position detection method comprising:
a light emitting process of emitting light to the display surface from a backlight apparatus having a plurality of light emitting elements for generating a plurality of light emitting points disposed in a rear of the display surface, the light being modulated by using position information which indicates the position in the display surface corresponding to a position of each of the plurality of light emitting points;
a light receiving process of receiving the light emitted to the display surface, from a front side of the display surface,
a modulating process of modulating the light received in said light receiving process, to thereby obtain the position information; and
an outputting process of outputting the position information obtained in said demodulating process.

20. A position detection method for detecting a position in a display surface to display information visually, said position detection method comprising:
a light emitting process of emitting light to the display surface from a backlight apparatus having a plurality of light emitting elements for generating a plurality of light emitting points disposed in a rear of the display surface, in light emission timing which varies depending on the position of each of the plurality of light emitting points;
a light receiving process of receiving the light emitted to the display surface, from a front side of the display surface; and
a position detecting process of detecting the position in the display surface on the basis of light reception timing of the light received in said light receiving process.
